(19) United States
(12) Patent Application Publication
(10) Pub. No.: US 2020/0376732 A1
(43) Pub. Date: Dec. 3, 2020

(54) INJECTION MOLDING MACHINE

(71) Applicant: Limworks, LLC, Ludington, MI (US)

(72) Inventor: John E. Burton, Ludington, MI (US)

(21) Appl. No.: 16/886,945

(22) Filed: May 29, 2020

Related U.S. Application Data
(60) Provisional application No. 62/855,020, filed on May 31, 2019.

(51) Int. Cl. B29C 45/74; B29C 45/20

(52) U.S. Cl. CPC B29C 45/74; B29C 45/20

(57) ABSTRACT

An injection molding machine with an injection system and a clamping system. The injection system may include an injection module and an injection module receiver. The injection module is removably installed in the injection module receiver and includes a nozzle for introducing material into the mold. The injection module receiver may include a cooling system for cooling at least a portion of the nozzle. The cooling system may include a nozzle sheath fitted about the nozzle. The intermediate space between the nozzle sheath and the nozzle may define a coolant chamber through which liquid coolant may be moved to cool the nozzle. The nozzle and nozzle sheath may be configured to cooperatively define a coolant supply passage and a coolant return passage. The nozzle may include a nozzle tip that is fluted to provide a coolant flow path from the coolant supply passage to the coolant return passage.

### FIELD OF THE INVENTION

The present invention relates to an apparatus for molding, and more particularly to an injection molding machine with a material injection system and a mold clamping system.

### BACKGROUND OF THE INVENTION

The invention relates to injection molding machines, such as the type that produce heat cured or thermo-setting materials such as but not limited to silicone rubber. Thermoset injection units are typically built upon a screw based injection system originally designed for thermoplastic polymers. A typical thermoplastic injection system first takes material in a pellet form from a hopper and feeds it into a heated barrel where a screw rotates to convey, compress, and mix the material before plunging to force the material into the mold cavity where the material cools to become solid in order to make a part. Upon the introduction of thermoset materials, the thermoplastic injection system was adapted to inject thermoset material using many of the same elements. A typical thermoset injection first takes material in a liquid form under pressure and feeds it into a barrel where a screw rotates to convey the material before plunging to force the material into the mold cavity where the material is heated to cure and become solid in order to make a part.

In plastic injection molding, plastic pellets are pre-heated in a hopper then a screw in a heated barrel turns and strokes the material into the mold. When switching materials or colors the entire injection system needs to be dismantled to fully clean the screw, barrel, nozzle and all components that come in contact with the material. Purging techniques exist but are not sufficient to completely clear out the injection system. An injection system tear down and cleaning can typically take a full day leaving the injection molding machine unavailable for production. These same plastic molding machines are used to mold thermoset materials like liquid silicone rubber (“LSR”) with some minor modifications. However, a complete tear down for cleaning is still required for both material change over and at the end of the production run since the material could cure to the point of locking the components together if left in the machine for days. Cleaning uncured thermoset material from injection components is more involved and time consuming as solvents are often needed to remove the sticky material that is comparable to tree sap.

At least one thermoset injection system has been developed to address these concerns by redeveloping a system from the ground up with a removable injection module that contains all or substantially the entire material flow path downstream from the material supply. For example, an injection molding machine with a removable injection module is shown in U.S. Pat. No. 10,239,246 entitled INJECTION MOLDING MACHINE, which issued Mar. 26, 2019 to Burton et al, which is incorporated herein by reference in its entirety. Injection molding machines incorporating the teachings of U.S. Pat. No. 10,239,246 to Burton provide a variety of notable advantages over other systems, particularly in connection with the use of liquid silicone rubber.

Other innovations in thermoset injection systems have been focused on keeping the material at a low enough temperature before it is injected so it will not cure before entering the mold cavity. One innovation is to build a mold in more than two plates with insulation material between the plate where the thermoset material first enters the mold and the heated mold cavity plate. One disadvantage of this approach is that is can increase the cost and complexity of the mold design. A further innovation is to pump liquid through cavities in the plates to be cooled allowing a large amount of heat to be removed. One disadvantage of conventional liquid cooling systems is that they are not configured to work with injection molding systems with removable injection modules.

Other innovations are focused on reducing the amount of voids in the final product due to trapped air or additional processes to remove extra material called flash. A typical mold has small passages to allow air inside the mold cavity to escape as material enters the mold cavity. Molds designed this way may produce parts with trapped air if material enters the mold cavity faster than the air can escape. It is undesirable to have voids in the part as it may adversely affect the physical properties or the aesthetics. Molds designed this way may also produce parts with additional material, called flash, if the material flows into the passages meant to allow the air to escape. It is undesirable to have flash on the part as it may require additional processing to remove. U.S. Pat. No. 10,239,246 to Burton provides an embodiment in which a vacuum system in integrated into the injection molding system. In one embodiment, the vacuum system includes a vacuum sleeve that is fitted around the nozzle of the injection module. The vacuum sleeve is capable of operatively engage the mold cavity to draw a vacuum in the mold cavity before the nozzle is seated. Once the desired vacuum is achieved, the nozzle can be seated to close off the mold cavity while it remains under vacuum. Material can then be introduced into the mold through the nozzle with the vacuum helping to draw material into the mold cavity and provide improved part quality.

A need exists to enhance the type of injection molding systems that have removable injection modules to include a cooling system and to do so without losing the ability to include an effective vacuum system.

### SUMMARY OF THE INVENTION

The present invention provides an injection molding system generally including an injection frame and a removably attached injection module. The injection frame includes an integrated liquid cooling system to cool a portion of the injection module and help to prevent material from curing the injection module prior to injection in to the mold. The liquid cooling system is integrated into the injection frame such that the injection module can be installed and removed from the injection frame without manipulation of the liquid cooling system.

In one embodiment, the liquid cooling system is configured to cool at least a portion of the nozzle of the injection module. In such embodiments, the injection frame may include a carrier plate configured to releasably receive the injection module in such a way as to arrange the nozzle in operative association with the liquid cooling system automatically as the injection module is installed on the injection frame.

In one embodiment, the liquid cooling system includes a liquid coolant supply that moves coolant through the cooling system by a pressure differential. For example, coolant may be introduced into the cooling system under positive pressure and/or withdrawn from the cooling system under negative pressure. In one embodiment, the liquid cooling system includes an inlet port for receiving a supply of coolant from the liquid coolant supply and an outlet port for returning coolant to the liquid coolant supply. The inlet and outlet ports may be affixed to the injection frame.

In one embodiment, the injection frame includes a nozzle sheath configured to receive the nozzle when the injection module is mounted to the injection frame. The nozzle sheath may be configured to be generally coextensive with the nozzle extending from nozzle base to nozzle tip.

In one embodiment, the exterior of the nozzle and the interior of the nozzle sheath cooperatively define one or more liquid flow paths through which a cooling liquid may be moved to cool the nozzle.

In one embodiment, the liquid cooling system includes a pair of seals that define an interior space to receive the cooling liquid. In one embodiment, the pair of seals includes an inner seal that forms a leaktight seal between the base of the nozzle and the nozzle base and an outer seal that forms a leaktight seal between the nozzle sheath and the tip of the nozzle.

In one embodiment, the external shape of the nozzle and the internal shape of the nozzle sheath are configured to define separate supply and coolant return paths. The coolant supply path may extend from the base of the nozzle sheath to the tip of the nozzle and the coolant return path may flow from the tip of the nozzle back to the base of the nozzle sheath.

In one embodiment, the nozzle base defines an inlet recess for supplying liquid to the coolant supply path and outlet recess for returning liquid from the coolant return path.

In one embodiment, the exterior of the nozzle and the interior of the nozzle sheath are shaped to define a longitudinally extending coolant supply path and a longitudinally extending coolant return path. For example, the interior of the nozzle sheath may be tubular and the exterior of the nozzle may be polygonal with the vertices of the polygon closely interacting with the interior of the nozzle sheath to define a plurality of longitudinal passages. More specifically, the interior space defined between the interior of the sheath and each side of the polygon may form a longitudinally extending passage capable of functioning a liquid flow path.

In one embodiment, the interior of the nozzle sheath is circular in cross section and the exterior of the nozzle is hexagonal in cross section. In this embodiment, the external dimensions of the nozzle and the internal dimensions of the nozzle sheath are selected so that the vertices provide a sufficient seal with the nozzle sheath to define six longitudinal flow paths.

In one embodiment, the nozzle tip may include a plurality of longitudinally extending flutes (or grooves) that allow liquid supplied through the coolant supply path to flow around the nozzle tip and into the coolant return path.

In one embodiment, the inlet port is in fluid communication with the base of the nozzle sheath through a first portion of the circumference and the outlet port is in fluid communication with the base of the nozzle sheath through a second portion of the circumference.

In a second aspect, the present invention provides an injection molding system having a vacuum system for drawing air from the mold cavity prior to injection. In one embodiment, the vacuum system includes a vacuum sleeve that is situated about the nozzle sheath. For example, the vacuum sleeve may be fitted coaxially about the nozzle sheath. The inside diameter of the vacuum sleeve may be larger than the outside diameter of the nozzle sheath to define an intermediate air flow path. A vacuum source may be coupled to the distant end of the vacuum sleeve to allow air to be drawn through the mold end of the vacuum sleeve.

In one embodiment, the vacuum sleeve extends beyond the nozzle sheath and the injection nozzle in a direction toward the mold. This allows the vacuum sleeve to engage the mold before the injection nozzle as the injection molding system is shuttled toward the mold. The vacuum sleeve may include a seal on the mold end. The seal is configured to create and air tight seal between the vacuum sleeve and the mold face. In one embodiment, the vacuum seal is created around the injection nozzle inlet so that the mold cavity is in fluid communication with the vacuum sleeve. As a result, when a vacuum is applied, air is drawn from the mold cavity.

In one embodiment, the vacuum sleeve is retractable to allow it to move into the injection molding system as the injection molding system moves farther forward to bring the nozzle into engagement with the mold inlet. The vacuum sleeve may be telescopically received within a sleeve base and may be capable of extending and retracting with respect to the sleeve base during operation of the system.

In one embodiment, the injection molding system includes a spring that urges the vacuum sleeve away from the sleeve base into its forward-most position, but is capable of compressing to allow the vacuum sleeve end to move telescopically into the sleeve base into a retracted position. The spring may be a coil spring that is fitted coaxially over the nozzle sheath and engages the innermost end of the vacuum sleeve end. In an alternative embodiment, the vacuum sleeve may be immovable, but it may include a seal that is capable of compressing, collapsing or otherwise allowing the injection nozzle to move into engagement with the mold after the vacuum has been drawn.

In use, the injection molding system may be moved forward toward the mold until the seal on the vacuum sleeve, but not the nozzle tip, has touched the mold face. In this position, the vacuum sleeve is sealed against the mold face in communication with the nozzle inlet. Since the nozzle tip has not yet contacted the mold face, a partial vacuum can then be drawn at the rear end of the vacuum sleeve to extract air from the mold cavity through the sprue at the nozzle inlet. While the mold cavity is held under vacuum, the injection molding system can be moved farther forward toward the mold until the nozzle tip seals against the mold face. During this second stage of travel, the vacuum sleeve remains sealed against mold face, but retracts into the injection system. Once in this position, the mold cavity is held under vacuum by the seal between the nozzle tip and the mold shut off surface. Material can be injected into the mold cavity under the aid of the partial vacuum. Since air can often be evacuated from the cavity very quickly, the motion to move the nozzle tip towards the mold may be continuous. In other words, a desired vacuum is achieved from time when the nozzle sleeve seal first contacts the mold face and the nozzle tip engages the nozzle seat and seats against the mold while under continuous motion.

The present invention provides a simple and effective injection molding system that is particularly well-suited for use with liquid silicone rubber (“LSR”) material. The releasably attachable injection module can be easily cleaned or swapped out with another injection module to run a different material or color for the same or different mold tool. Once removed from the injection molding system, the injection module may be placed in cold storage to prevent curing of material between uses to avoid cleaning altogether. All of these options prevent machine down time and related costs due to material change over. The incorporation of actuators into the carrier plate reduces the size, weight and complexity of the injection module. It also facilitates the use of interchangeable injection modules because each injection module is not required to include its own set of actuators. Attachment and removal of the injection module can be facilitated with quick attachment structures to couple the actuators to the movable components in the injection module. The liquid cooling system helps to prevent material from curing in the injection module prior to injection into the mold. The liquid cooling system may be fully integrated into the injection frame so that the injection module can be attached and removed without the need to manipulate the liquid cooling system. When implemented, the vacuum system reduces the force required to inject material into the mold cavity and helps to improve part quality. Integration of a retractable vacuum sleeve provides an effective structure that is highly reliable and can operate with limited additional components. If desired, the liquid cooling system may implemented so that it can operate to cool at least a portion of the injection module during all steps of the molding process, for example, including the steps of filling the injection module with material, applying a vacuum to the mold cavity, injecting material into the mold cavity and waiting for the material to cure in the mold.

The present invention is described with reference to various alternative embodiments. In one illustrated alternative embodiment, the present invention is incorporated into a horizontal mold press. In this embodiment, the present invention includes a variety of alternative components, including an alternative injection module and an alternative clamping system. Although this embodiment includes a variety of alternative components, it should be understood that these alternative components are not limited to use in connection with one another as shown and described in connection with the horizontal mold press embodiment, but instead may be used individually or in essentially any combination.

These and other features of the invention will be more fully understood and appreciated by reference to the description of the embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 is a front perspective view of an injection molding machine in accordance with an embodiment of the present invention.

FIG. 2 is a rear perspective view of the injection molding machine.

FIG. 3 is a top view of the injection molding machine.

FIG. 4 is a side view of the injection molding machine.

FIG. 5 is a front view of the injection molding machine.

FIG. 6 is a top view of a portion of the injection molding machine showing the closed mold.

FIG. 7 is a sectional view of a portion of the molding machine taken along line VII-VII of FIG. 6.

FIG. 8 is an enlarged view of area VIII of FIG. 7.

FIG. 9 is a sectional view of the material reservoir.

FIG. 10 is a partially exploded perspective view of the injection molding system.

FIG. 11 is a partially exploded top view of the injection molding system.

FIG. 12 is a partially exploded front view of the injection molding system.

FIG. 13 is a partially exploded sectional side view of the injection molding system taken along line XIII-XIII of FIG. 12.

FIG. 13A is an enlarged view of a portion of FIG. 13.

FIG. 14 is a section view of the injection module and injection module receiver with portions removed to show portions of the valve actuator.

FIG. 15 is a partially exploded perspective view showing the injection module and the injection module receiver separated from the remainder of the injection frame.

FIGS. 16A-C show the process of installing and clamping the injection module to the injection frame.

FIG. 17 is a sectional view of the injection module with the rotational valve in the fill position with the vacuum system removed.

FIG. 17A is an enlarged view of a portion of FIG. 17.

FIG. 18 is a sectional view of the injection module with the rotational valve in the inject position including the vacuum system.

FIG. 18A is an enlarged view of a portion of FIG. 18.

FIG. 19 is a first exploded view of the outer portions of the injection module receiver.

FIG. 20 is a second exploded view of the inner portions of the injection module receiver.

FIG. 21 is a perspective view of the injection module and injection module receiver with portions removed to show the rotational valve actuator.

FIG. 22 is a first exploded perspective view showing portions of the cooling system.

FIG. 23 is a second exploded perspective view showing portions of the cooling system.

FIG. 24 is a perspective view of the injection module and injection module receiver with portions removed to show the nozzle extending through the receiver insert.

FIG. 25 is a sectional view of the injection module and injection module receiver with portions removed to show portions of the cooling system.

FIG. 26 is a sectional view through the nozzle sheath and the nozzle showing the plurality of potential flow passages defined by the hexagonal shape of the nozzle.

FIG. 27 is a sectional view through the nozzle sheath and the nozzle tip showing the plurality of potential flow passages defined by the flutes.

FIG. 28 is a perspective view of the injection module and injection module receiver showing portions of the vacuum system in exploded format.

FIG. 29 is a sectional view of portions of the injection module and injection module receiver with portions removed to show portions of the cooling system and the vacuum system.

FIG. 30 is a sectional view of a portion of the injection molding machine showing the injection system in the vacuum position.

FIG. 31 is an enlarged sectional view of a portion of the injection module housed within the injection module receiver with the rotational valve in the fill position.

FIG. 32 is an enlarged sectional view of a portion of the injection module with the rotational valve in the inject position.

FIG. 33 is a perspective view of an alternative injection module.

FIG. 34 is an exploded perspective view of a portion of the alternative injection module.

FIG. 35 is an exploded perspective view of an alternative injection rod and alternative injection cylinder.

FIG. 36 is an exploded perspective view of a portion of the injection molding system including a latch assembly.

FIG. 37 is a sectional view of a portion of an injection molding system incorporating the alternative injection module and the alternative injection rod.

FIG. 38 is a sectional view of a portion of an injection molding system incorporating the alternative injection module.

FIG. 39 is an enlarged sectional view of area 39 of FIG. 38.

FIG. 40 is a partially exploded perspective view of a portion of the injection molding machine showing the alternative injection module separated.

FIG. 41 is an enlarged view of area 41 of FIG. 40.

FIG. 42 is a sectional view of a portion of the injection molding machine showing the alternative injection module installed.

FIG. 43 is an enlarged view of area 43 of FIG. 42.

### DESCRIPTION OF CURRENT EMBODIMENTS

Overview.

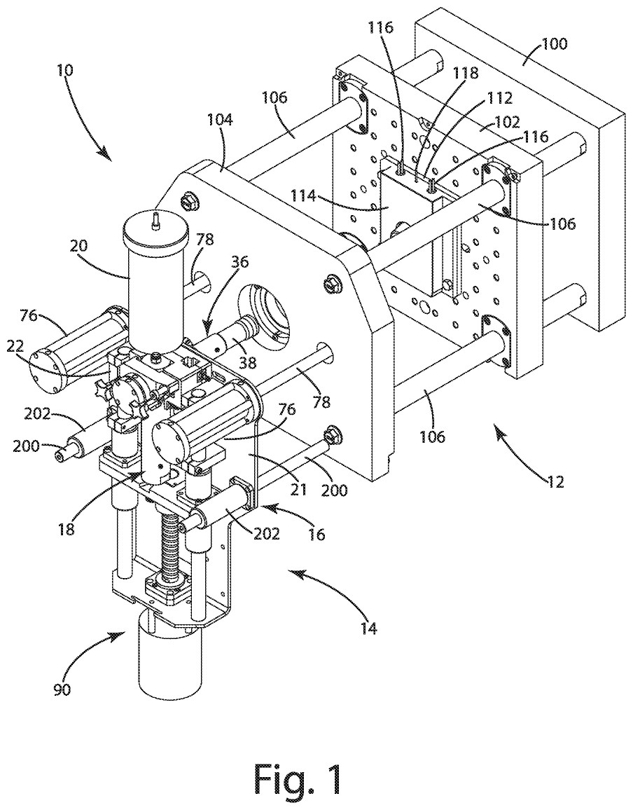

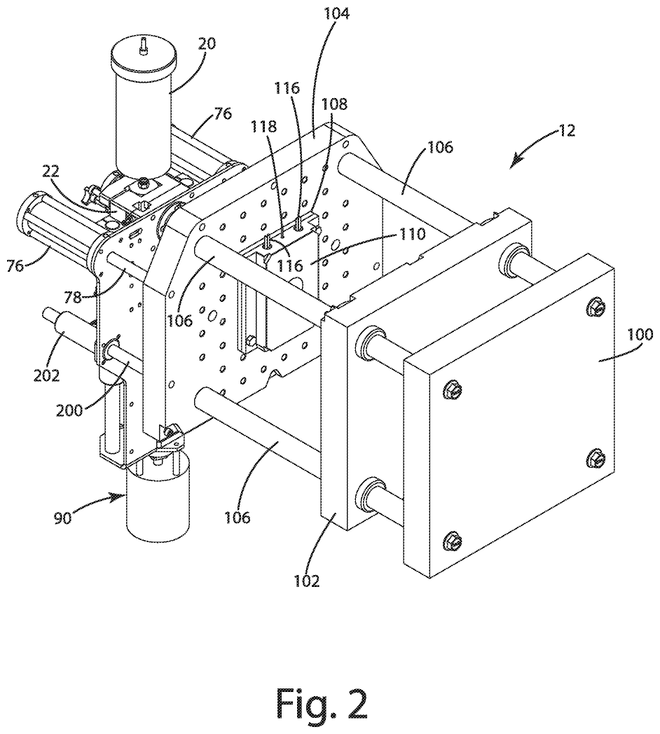

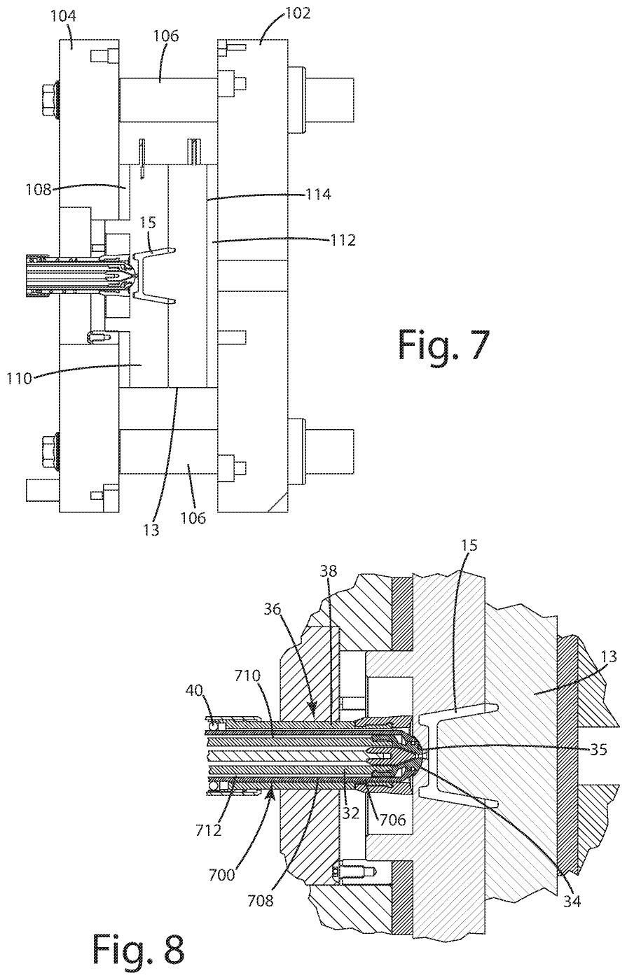

An injection molding machine in accordance with an embodiment of the present invention is shown in FIGS. 1-2, and generally designated 10. The injection molding machine 10 generally includes an injection molding system 14 mounted to a press, such as horizontal mold press 12. The mold press 12 is generally conventional and includes a mold 13 that defines a mold cavity 15 for forming the desired part (See FIG. 7). The injection molding system 14 is mounted adjacent the horizontal mold press 12 and is configured to selectively inject material into the mold cavity 15. The injection molding system 14 generally includes an injection frame 16 mounted to the horizontal mold press 12, an injection module 18 removably attachable to the injection frame 16 and a material reservoir 20 or other material supply connected by hose or reservoir 20 removably mounted to the injection module 18 for supplying material to the injection module 18. The injection molding system 14 also includes an integrated liquid cooling system 700 configured to cool at least a portion of the injection module 18 to help prevent material from curing in the injection module 18 prior to injection into the mold cavity 15. The liquid cooling system 700 is integrated into the injection frame 16 such that the injection module 18 can be easily removed from the injection molding system 14 without the need to manipulate the liquid cooling system 700.

In the illustrated embodiment, the injection module 18 includes a nozzle 32 for delivering material to the mold 13 and the liquid cooling system 700 is configured to move a cooling liquid over at least a portion of the nozzle 32. In this embodiment, the cooling system 700 includes a nozzle sheath 706 mounted to the injection frame 16. The nozzle sheath 706 defines an interior configured to receive the nozzle 32 as the injection module 18 is mounted to the injection frame 16. In this embodiment, the intermediate space between the nozzle 32 and the nozzle sheath 706 defines a chamber 708 around the exterior of the nozzle 32 and nozzle tip 34 to receive cooling liquid. For example, inner and outer seals 720 and 722, respectively, may be disposed toward opposite ends of the nozzle 32 to assist in forming the intermediate sealed chamber 708. In the illustrated embodiment, the intermediate chamber 708 is configured to define a coolant supply path 710 through which liquid coolant is moved along the nozzle 32 to the nozzle tip 34 and a coolant return path 712 through which coolant returns from the nozzle tip 34 along the nozzle 32.

In the illustrated embodiment, the injection frame 16 generally includes a mounting plate 21 that supports an injection module receiver 22 and a plurality of actuators that are configured to move the injection frame 16 toward and away from the mold 13 and to operate the various parts of the injection module 18. The injection module 18 is releasably attached to the injection module receiver 22. The injection module 18 includes at least a portion of the material flow path from the material supply connection 20 to the mold 13, including the nozzle 32 and the nozzle tip 34. When desired, the injection module 18 can be removed from the injection frame 16. This allows the injection module 18 to be easily cleaned or, if not empty, to be placed in a refrigerated location where the material inside the injection module 18 will not cure for an extended period. It also allows the interchangeable use of different injection modules 18 on the same injection molding system 14.

The injection molding system 14 may also include a vacuum system 36 for drawing air from the mold cavity 15 prior to injection. In this embodiment, the vacuum system 36 includes a vacuum sleeve 38 that is situated about the nozzle sheath 706. The vacuum sleeve 38 extends forwardly beyond the nozzle 32 so that the vacuum sleeve 38 contacts the mold 13 prior to the nozzle tip 34. The vacuum system 36 also includes a vacuum source (not shown) for applying a partial vacuum to the vacuum sleeve 38. In the illustrated embodiment, the vacuum sleeve 38 is retractable with respect to the nozzle 32. The injection molding system 14 of the illustrated embodiment includes a spring 40 that urges the vacuum sleeve 38 into its forward-most position, while allowing the vacuum sleeve 38 to move rearwardly as the injection frame 16 is moved from the vacuum position to the injection position. In use, the injection frame 16 may be moved toward the mold into the vacuum position in which the vacuum sleeve 38, but not the nozzle 32, is engaged with the mold 13. In this position, the vacuum source may be operated to create a partial vacuum within the mold cavity 15. While the mold cavity 15 is held under vacuum, the injection frame 16 can be moved farther toward the mold 13 until the nozzle tip 34 seals against the mold face. During the second stage of travel, the vacuum sleeve 38 remains sealed against the mold face while retracting into the injection frame 16 as spring 40 is increasingly compressed. Once the injection frame 16 has been moved into the injection position, material can be injected into the mold cavity 15 with the aid of the partial vacuum.

Although the present invention is described in the context of a conventional horizontal mold press, it should be understood that the present invention can be incorporated into a wide range of molding machinery, including a variety of alternative vertical and horizontal presses. The various cylinders incorporated into the present invention may be pneumatic cylinders, hydraulic cylinders or essentially any other actuators capable of providing reciprocating motion.

Directional terms, such as “vertical,” “horizontal,” “top,” “bottom,” “upper,” “lower,” “inner,” “inwardly,” “forward,” “rearward,” “outer” and “outwardly,” are used to assist in describing the invention based on the orientation of the embodiments shown in the illustrations. The use of directional terms should not be interpreted to limit the invention to any specific orientation(s).

General Construction and Operation.

### A. Mold Press

As noted above, an injection molding system in accordance with the present invention may be configured to operate with a wide variety of different press and mold assemblies. In the illustrated embodiment, the injection molding machine 10 includes a generally conventional horizontal mold press 12 that supports a mold 13 with an internal mold cavity 15. The injection molding system 14 is operatively associated with the mold press 12 and is configured to selectively introducing material into the mold 13 to form a part in the shape of the mold cavity 15. For purposes of disclosure, the injection molding machine 10 is described with a horizontal mold press 12 (or horizontal die set) having a mold 13 that is assembled and formed from self-aligning rapid tooling inserts and frames, such as those made by DME and Progressive Components. Given that the horizontal mold press 12 and associated mold assembly are generally conventional, they will not be described in detail. However, the general structure and function of the mold press 12 will be described with sufficient detail to facilitate disclosure of the present invention.

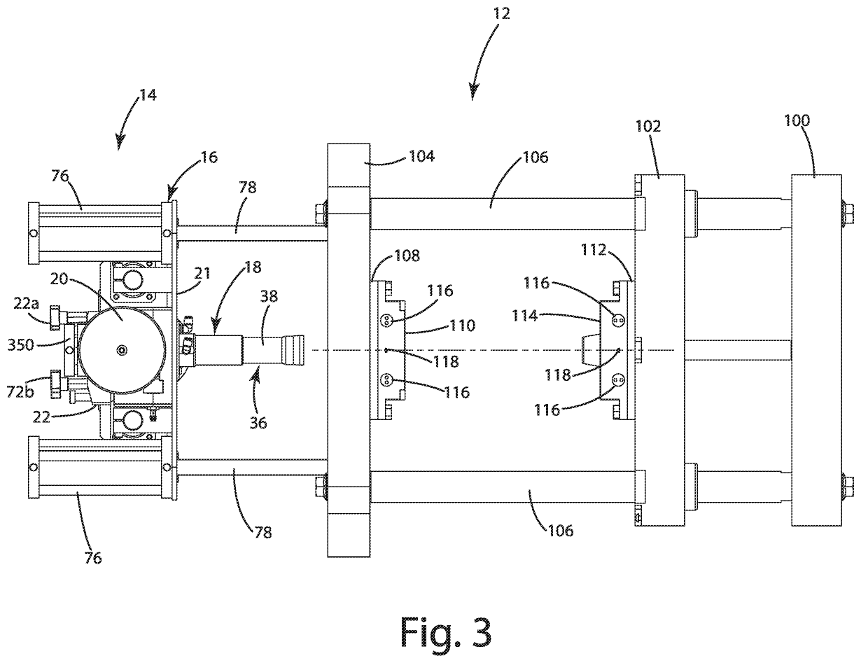

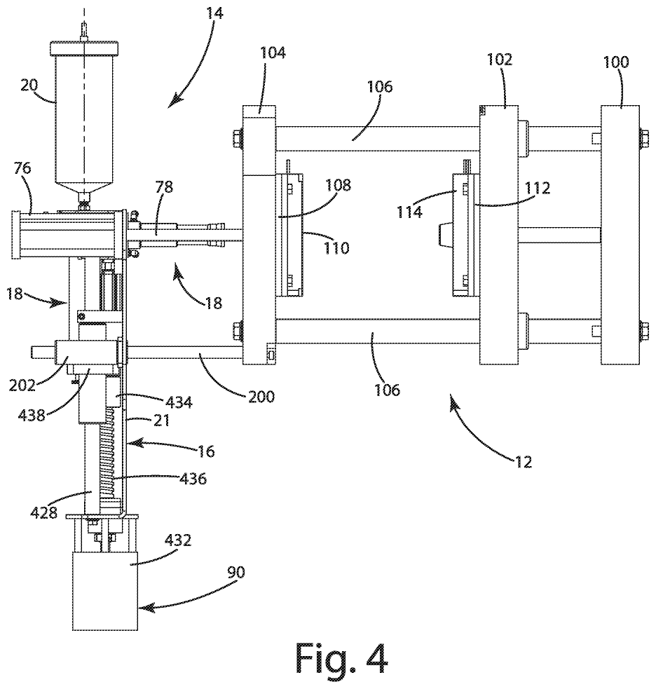

Referring now to FIGS. 1-8, the mold press of the illustrated embodiment is a horizontal mold press 12 generally including an end platen 100, a moving platen 102 and an injection platen 104 that are joined by four guide rods 106. An A-side insulator plate 108 and an A-side cavity insert 110 are mounted to the injection platen 104 (See FIGS. 3 and 4). A B-side insulator plate 112 and a B-side cavity insert 114 are mounted to the moving platen 102 (See FIGS. 3 and 4). The A-side cavity insert 110 and B-side cavity insert 114 are configured so that when brought together, they cooperatively form a mold cavity 15 in the shape of the desired part (See FIGS. 7 and 8). A plurality of heater cartridges 116 and a mold temperate sensor 118 may be fitted into the A-side cavity insert 110 and/or the B-side cavity insert 114. The heater cartridges may be replaced by other heating apparatus, such as heating platens or other similar structures. Although not shown, the mold assembly may also include a generally conventional cavity core/ejector pin assembly. For example, a cavity core/ejector pin assembly may be coupled to an ejector plate, and the ejector plate may be movable by operation of an ejector cylinder. In use, the ejector cylinder may be extended to move the ejector plate and consequently the cavity core/ejector pin assembly to move a molded part from the mold cavity 15.

### B. Injection Molding System

As noted above, the present invention includes an injection molding system 14 configured to introduce material into the mold 13 supported in the mold set 12. Referring now to FIGS. 1, 2 and 15, the injection molding system 14 is movably mounted relative to the horizontal die set 12 by a clamping system. In this embodiment, the injection molding system 14 is reciprocal movable toward and away from the mold press 12 to provide selective engagement between the injection molding system 14 and the mold set supported by the mold press 12. This allows the injection molding system 14 to be brought into engagement with the mold 13 to introduce material and to be drawn away from the mold 13 to facilitate opening of the mold and removal of the molded part. The injection molding system 14 may include essentially any structure that provides selective engagement and disengagement with them mold 13.

For purposes of disclosure, the present invention is described in the context of a clamping system that is affixed to the mold press 12 and is operable to selectively move essentially the entire injection molding system 14 toward and away from the mold press 12. For example, as perhaps best shown in FIGS. 1, 4 and 15, the injection molding system 14 of the illustrated embodiment may be supported upon a pair of guide rods 200 that extend from the mold press 12. More specifically, the injection molding system 14 may include a mounting plate 21 that is coupled to the guide rods 200 by a pair of guide sleeves 202. The guide sleeves 202 are affixed to the mounting plate 21, for example, by fasteners, and the guide sleeves 202 are slidably fitted over the guide rods 200. The guide rods 200 and guide sleeves 202 are configured to support the full weight of the injection molding system 14. In the illustrated embodiment, the injection molding system 14 includes a pair of nozzle clamp cylinders 76 configured to move the injection frame 16 with respect to the injection platen 104. The illustrated nozzle clamp cylinders 76 are conventional 2-position cylinders that have a cylinder body affixed to the mounting plate 21 and a rod 78 affixed to the injection platen 104. In operation, the nozzle clamp cylinders 76 can be extended and retracted to move the injection molding system 14 toward and away from the injection platen 104 along the guide rods 200. The motion is used to move the nozzle tip 34 into and out of the nozzle seat 35 as described in more detail below. The design and configuration of the structure for supporting and moving the injection molding system 14 relative to the mold press 12 may vary from application to application as desired. The illustrated embodiment includes two nozzle cylinders 76 disposed at opposite upper corners of the mounting plate 21, but the number and position of nozzle cylinders may vary. The nozzle cylinders 76 of the illustrated embodiment are pneumatic cylinders. However, the pneumatic cylinders may be replaced by essentially any other actuator(s) capable of selectively moving the injection frame 16 to bring the injection module 18 into engagement with the material inlet on the mold. For example, the pneumatic cylinders may be replaced hydraulic cylinders or by a motor and linear drive arrangement. Further, other arrangements could move the mold towards the injection molding system or the injection molding system could be held against the mold at all times if desirable. Such could be the case with room temperature UV cured material.

As noted above, the injection molding system 14 may be incorporated into a wide range of alternative mold presses. By way of example and not limitation, the present invention may be incorporated into the different press and mold assemblies disclosed in U.S. Pat. No. 10,239,246 entitled INJECTION MOLDING MACHINE, which issued Mar. 26, 2019 to Burton et al, which is incorporated herein by reference in its entirety.

In the illustrated embodiment, the injection molding system 14 generally includes an injection frame 16, an injection module 18 and a material reservoir 20 attached to the injection module by a supply connection. The injection frame 16 includes a generally includes a mounting plate 21, an injection module receiver 22 and a plurality of actuators that are configured to move the injection frame 16 toward and away from the mold 13 and to operate the various parts of the injection module 18. The mounting plate 21 is movably mounted to the guide rods 200 and functions as a carrier for the various components of the injection molding system 14. In this embodiment, the mounting plate 21 is configured to receive and support the injection module receiver 22, the nozzle clamp cylinders 76, the guide sleeves 202 and the injection rod actuator 90 as shown and described below. The design and configuration of the mounting plate 21 may vary from application to application, but in the illustrated embodiment is a somewhat rectangular vertically-extending plate with a horizontal lip extending from its lower end.

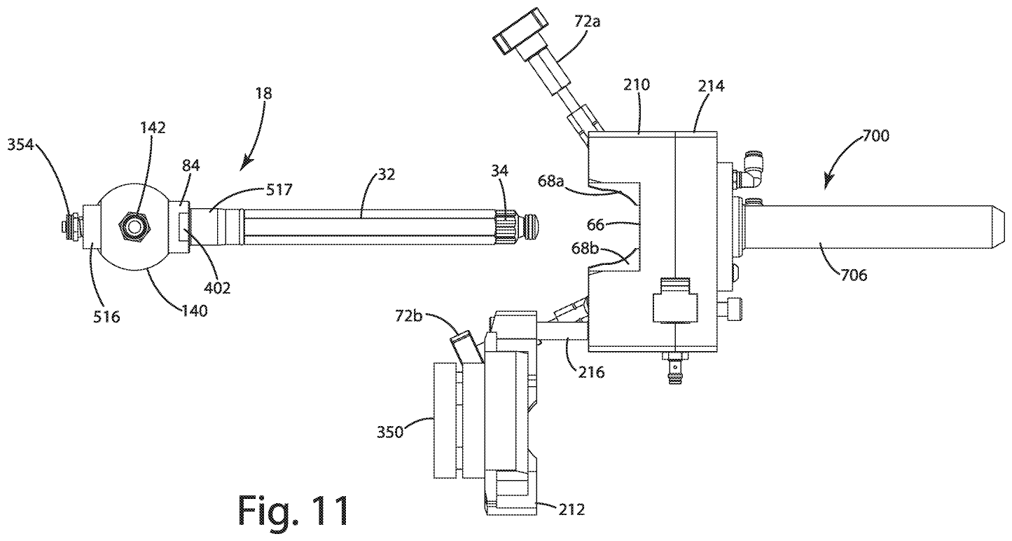

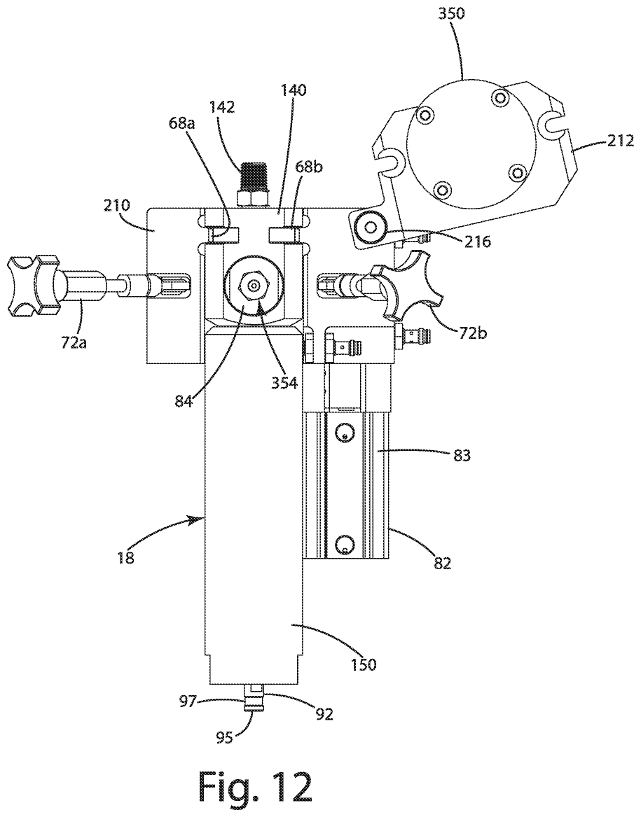

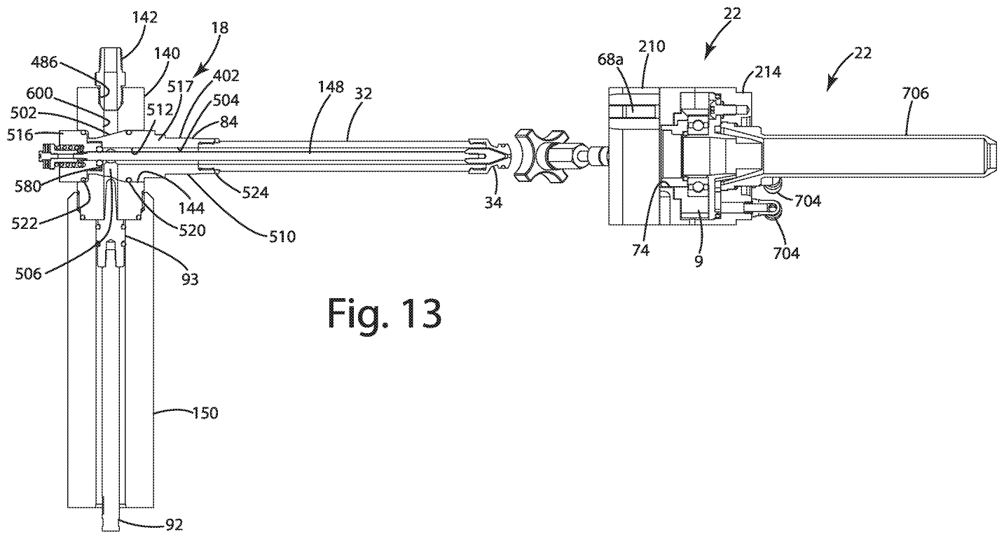

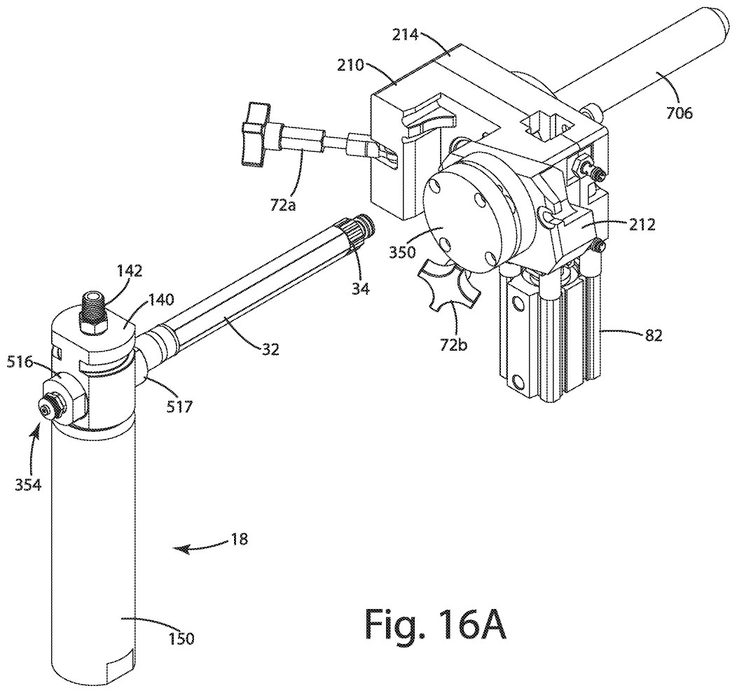

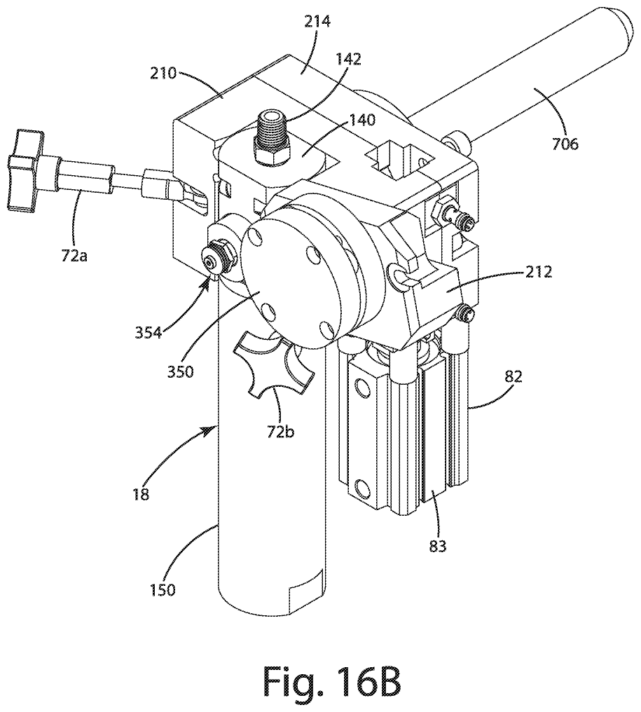

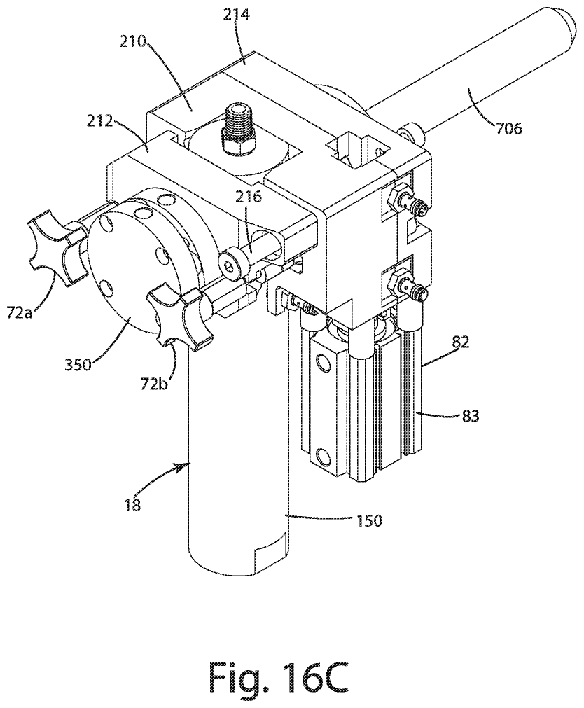

In the illustrated embodiment, the injection module receiver 22 is mounted to the outer face of the mounting plate 21 and is configured to removably receive the injection module 18. In the illustrated embodiment, the injection module receiver 22 generally includes a receiver plate 210 for removably seating the injection module 18, a manifold clamp 212 for securing the injection module 18 in the injection module receiver 22, a valve actuator 82 for operating the rotational valve 84 in the injection module 18 and a nozzle base 214 that closes the inner end of the injection module receiver 22. The receiver plate 210 defines a seat 66 for removably receiving the main body of the injection module 18. A pair of guide rails 68a-b may extend along opposite sides of the seat 66 where they can be received in corresponding guide slots 70a-b defined in the injection module 18 (See FIGS. 10 and 11). The receiver plate 210 defines a nozzle aperture 74 that allows the nozzle 32 to extend through the receiver plate 210 toward the mold 13. The manifold clamp 212 is pivotally mounted to the receiver plate 210, for example, by mounting bolt 216, and is configured to pivot about the mounting bolt 216 between an open position in which the injection module 18 can be fitted into the receiver plate 210 (See FIG. 12 and FIGS. 16A-C) and a closed position in which the injection module 18 is secured in the injection module receiver 22. The receiver 22 may also include a pair of swing clamps 72a-b that can be used to secure the manifold clamp 212 in the closed position. The swing clamps 72a-b may be supplemented or replaced by other attachment structure, such as latches or fasteners.

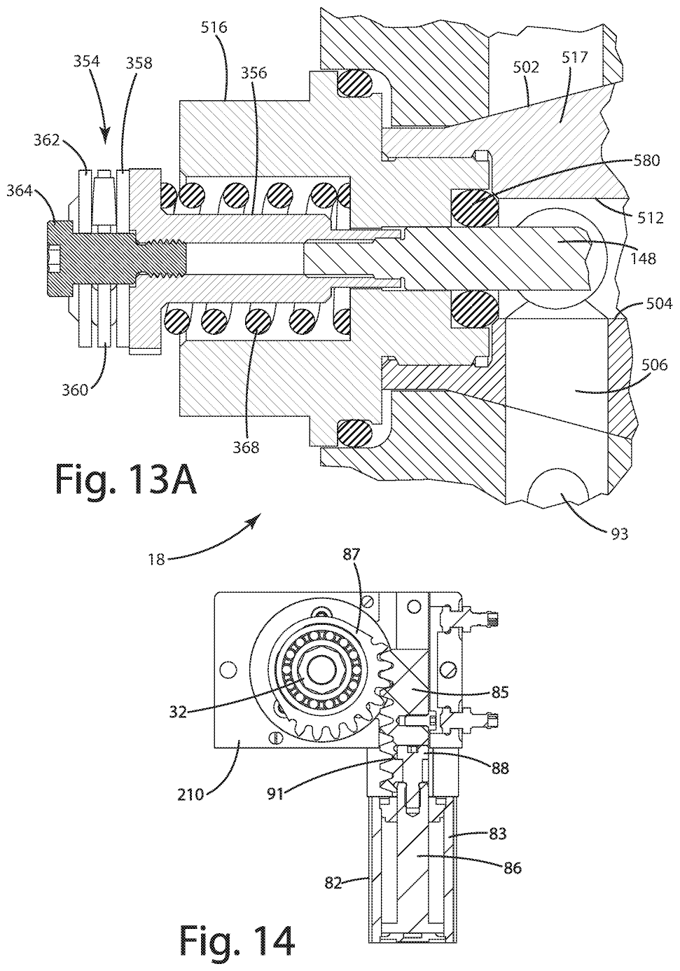

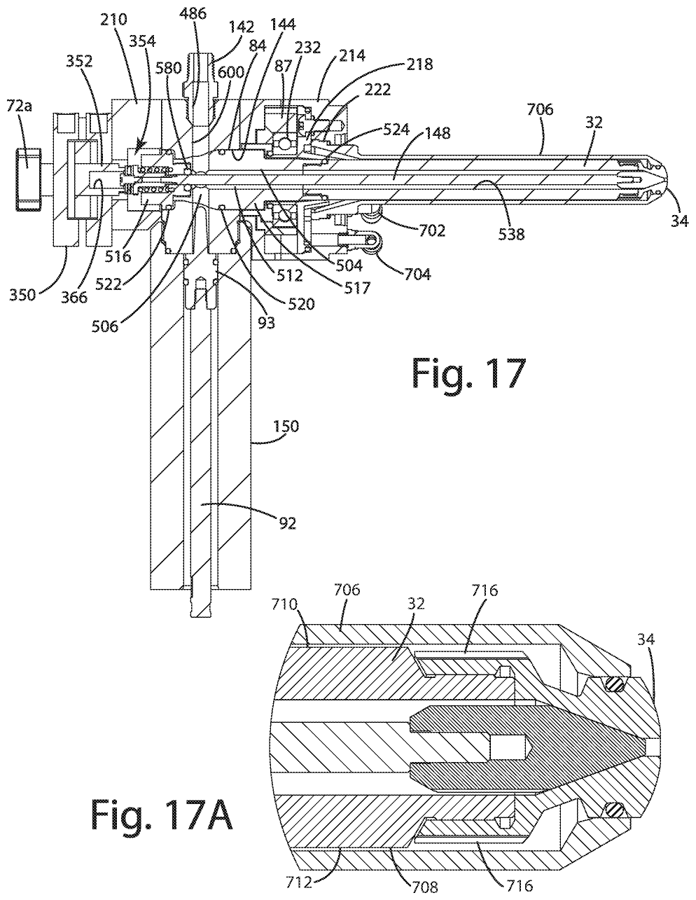

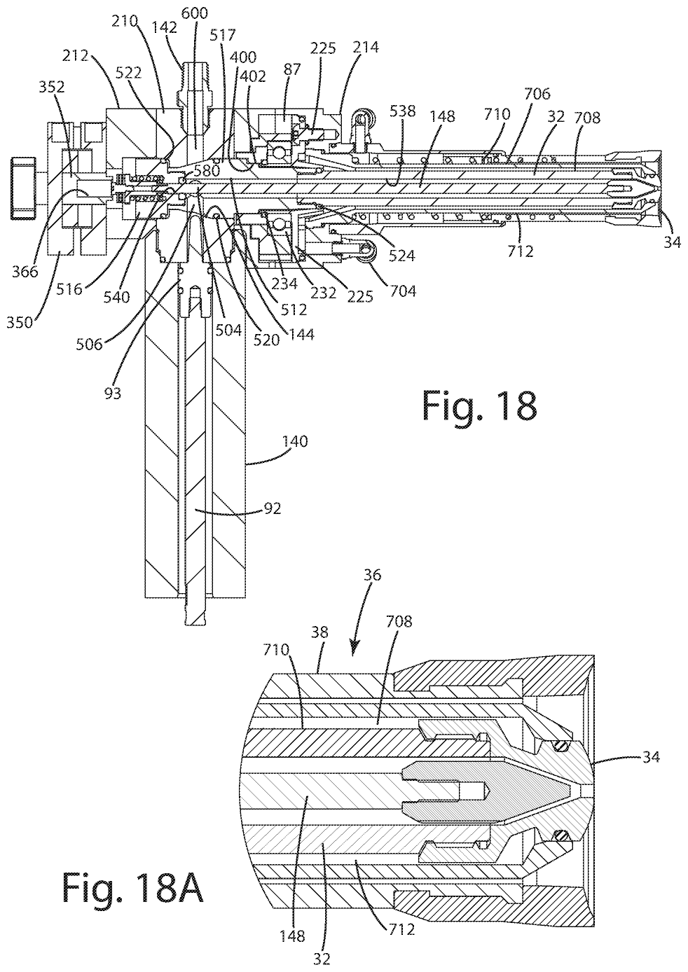

The manifold clamp 212 includes a needle cylinder 350 that operates to extend and retract the needle 148 extending through the interior of the nozzle 32. As shown in FIGS. 16C and 17, the needle cylinder 350 is mounted to the face of the manifold clamp 212 and includes a rod 352 that extends through the manifold clamp 212 to engage the outer end of the needle 148. In this embodiment, the needle 148 is spring-biased into the open position and extension of the needle cylinder 350 operates to move the needle 148 against the spring bias and close the needle 148 against the nozzle tip 34. In this embodiment, the rotational valve 84, nozzle 32 and needle 148 are rotated between a fill position (See FIG. 17) and an inject position (See FIG. 18) while the needle 148 is under load from the needle cylinder 350. To facilitate rotation of those components while under load, the outer end of the needle 148 is fitted with a thrust bearing assembly 354. Referring now to FIG. 13, the thrust bearing assembly 354 generally includes a T-nut 356, an inner washer 358, a thrust bearing 360 and an outer washer 362. The T-nut 356 is secured to the outer end of the needle 148, for example, by threading. The inner washer 358, thrust bearing 360 and outer washer 362 are, in turn, secured to the T-nut 356 by a shoulder screw 364. As shown in FIG. 17, the rod 352 of the needle cylinder 350 defines an internal bore 366 of sufficient size to pass around the shoulder screw 364 and directly engage the outer washer 362. When the rotational valve 84 and needle 148 are rotated, the thrust bearing 360 allows the outer washer 362 to remain stationary while the inner washer 358 rotates with the rational valve 84. As noted above, the needle 148 is spring-biased toward the open position. In this embodiment, the spring-bias is achieved by a compression spring 368 fitted between the T-nut and the outer end of the rotational valve 84 to bias the needle 148. In this embodiment, the needle cylinder 350 is a pneumatic or hydraulic cylinder, but it may be replaced by other linear actuators capable of providing the desired movement to the needle 148.

In the inner side of the injection module receiver 22 is closed by a nozzle base 214. The nozzle base 214 supports the nozzle sheath 706 and the receiver insert 218. More specifically, the nozzle base 214 defines a stepped circular through-hole 220 that receives the enlarged circular head 222 of the nozzle sheath 706 (described in more detail below). An O-ring seal 224 is fitted between the head 222 and the stepped through-hole 220. The receiver insert 218 is generally disc-shaped and is secured in the stepped through-hole 220 over the head 222. For example, the receiver insert 218 may be secured to the nozzle base 214 in the stepped through-hole 220 by a plurality of screws 225. O-ring seals may be fitted around each screw 226. Further, a large O-ring seal 228 may be fitted between the receiver insert 218 and the nozzle base 214. In this embodiment, the receiver insert 218 includes a throat 230 that receives the pinion bearing assembly 232 (described below). An O-ring seal 234 may be fitted between the bearing assembly 232 and the pinion insert 236 (described below).

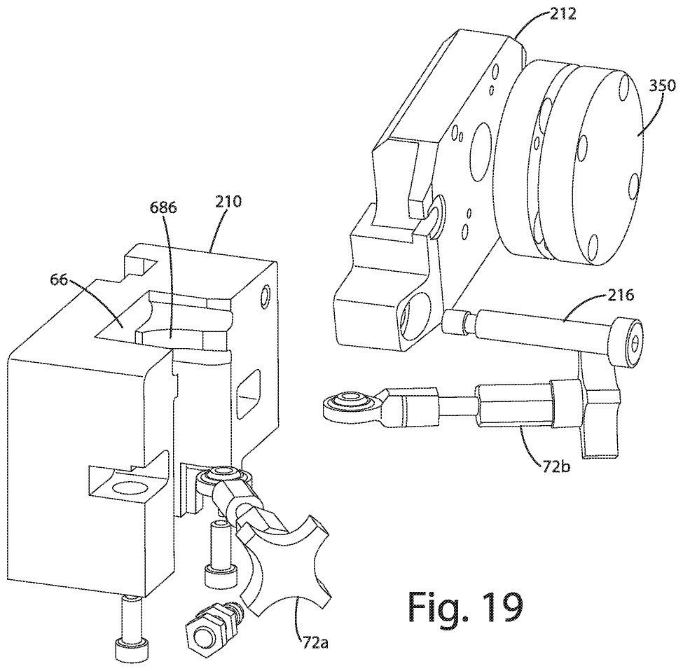

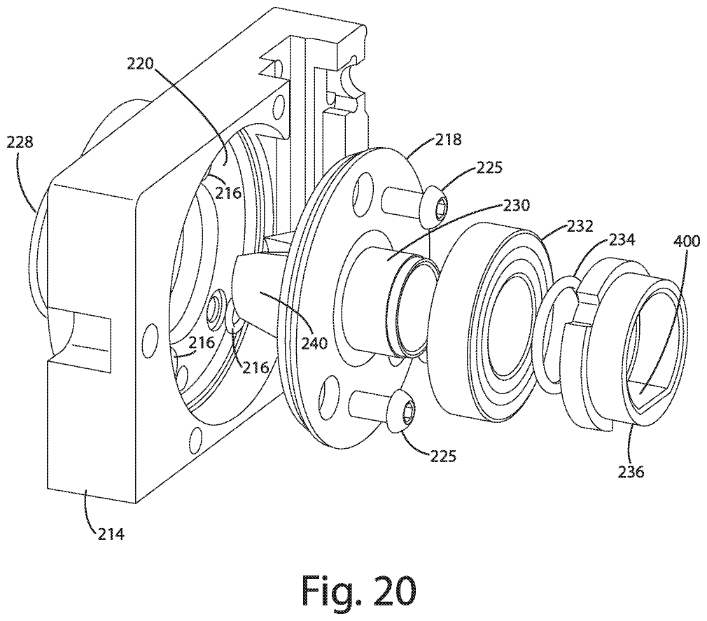

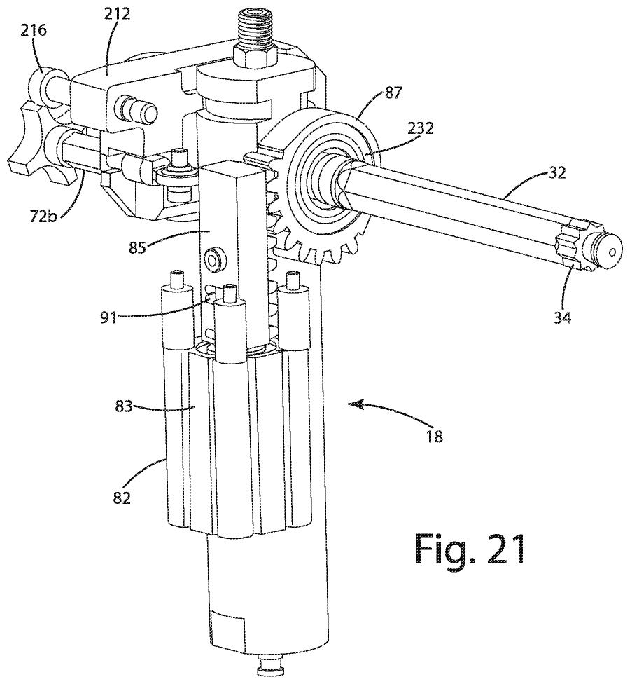

The valve actuator 82 is configured to operate the rotational valve 84 in the injection module 18. In the illustrated embodiment, the valve actuator 82 includes a linear actuator that provides rotational movement of the rotational valve 84 through a rack-and-pinion arrangement. Referring now to FIGS. 10 and 14, the linear actuator 83 is mounted to the undersurface of the injection module receiver 22 and is capable of reciprocating motion that allows it to rotate the valve 84 approximately ninety degrees between the fill and inject positions. In the illustrated embodiment, the linear actuator 83 is coupled to the rotational valve 84 using a generally conventional rack-and-pinion arrangement that converts linear motion of the actuator into rotational movement of the valve. In this embodiment, the linear actuator 83 includes a rod 86 that terminates in a head 88, such as a bolt threaded into the end of the rod 86. The head 88 is configured to operatively interfit with a T-slot 91 defined in a rack 85. Referring now to FIG. 21, the rack 85 is, in turn, mated with a pinion 87 that encircles the rotational valve 84. The pinion 87 is supported upon a bearing assembly 232 and is coupled to a pinion insert 236. When the injection module 18 is installed in the injection module receiver 22, the pinion insert 236 mechanically interconnects the pinion 87 with the rotational valve 84. The pinion insert 236 includes an outer surface that is keyed to the interior of the pinion 87 (for example, by an arrangement of fingers that fit into corresponding slots in the pinion 87) and an inner surface that is keyed to the rotational valve 84 (for example, by a pair drive flats 400 that engage with a corresponding drive flats 402 on the rotational valve 84 (See FIGS. 18-21). The arrangement of flats allows the rotational valve actuator 82 to be quickly and easily coupled to the rotational valve 84 automatically as the injection module 18 is seated in the injection module receiver 22. The valve actuator 82 and the rotational valve 84 are merely exemplary and they may be replaced by a variety of alternative types of valves and corresponding actuators.

The illustrated rotational valve actuator 82 is merely exemplary and it may be replaced by other actuators configured to operate the valve. For example, other types of rotary valve actuators may be used. As another example, a linear actuator may be used when the injection module 18 includes a linear valve (rather than rotary valve). In some applications, no valve actuator may be necessary. For example, the injection module valve arrangement may include one or more directional valves (e.g. a rotational valve or rotary valve) or it may include one or more check valves. In an alternative embodiment, a check valve (not shown) may be provided at the material supply connection 20 to allow material into the manifold as the injection rod 92 is retracted then allow material to be ejected from the manifold through the nozzle 32 when the injection rod 92 is extended while preventing material from going back the way it came.

The injection module receiver 22 includes an integrated liquid cooling system 700 that provides a structure for circulating a liquid coolant over at least a portion of the nozzle 32. In the illustrated embodiment, the liquid cooling system 700 is integrated into the injection frame 16 so that the injection module 18 can be installed and removed from the injection frame 16 without manipulation of the liquid cooling system 700. The liquid cooling system is configured to circulate a liquid coolant over at least a portion of the nozzle 32 of the injection module 18. The portion of the nozzle 32 receiving the liquid coolant may vary from application to application.

In the illustrated embodiment, the liquid cooling system 700 is integrated into the injection module receiver 22 such that the nozzle 32 and nozzle tip 34 come into operative association with the liquid cooling system 700 automatically as the injection module 18 is installed in the injection receiver 22. The liquid cooling system 700 of the illustrated embodiment includes a nozzle sheath 706 having an interior configured to receive the nozzle 32 when the injection module 18 is mounted to the injection frame 16. The nozzle sheath 706 of the illustrated embodiment is generally coextensive with the nozzle 32 extending from the nozzle base 214 over the nozzle tip 34 (See FIG. 17).

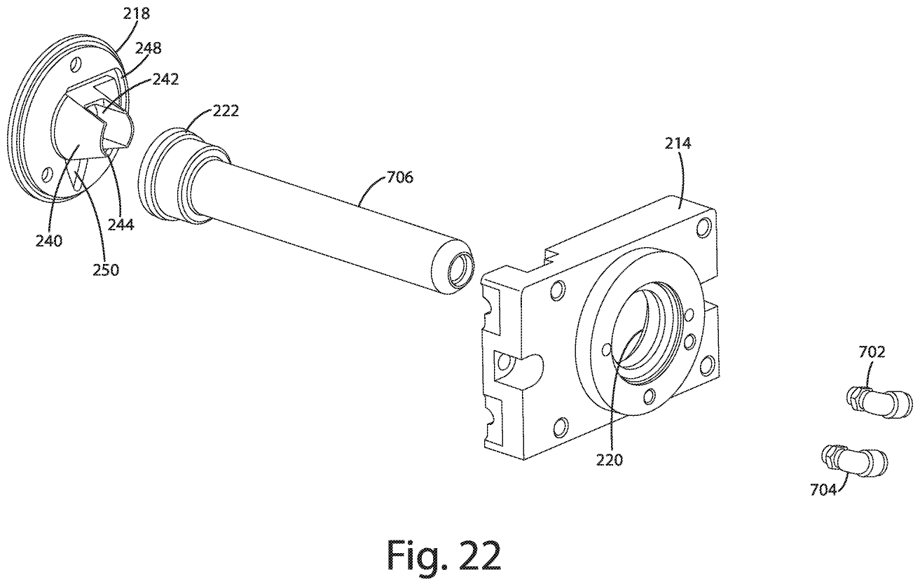

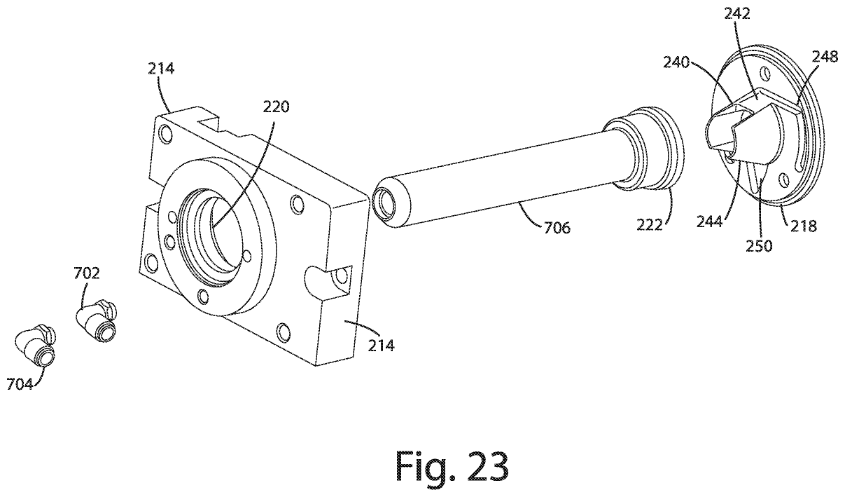

In the illustrated embodiment, the liquid cooling system 700 generally includes the nozzle sheath 706 that is fitted through the nozzle base 214, a receiver insert 218 that is affixed to the nozzle base 214 over the nozzle sheath 706 and a plurality of liquid coolant passageways that guide liquid coolant (See FIGS. 22 and 23). As noted above, the nozzle base 214 defines a stepped circular through-hole 220 that receives the enlarged circular head 222 of the nozzle sheath 706. An O-ring seal 224 is fitted between the head 222 and the stepped through-hole 220. The receiver insert 218 is generally disc-shaped and is secured in the stepped through-hole 220 over the head 222. For example, the receiver insert 218 may be secured to the nozzle base 214 in the stepped through-hole 220 by a plurality of screws 225. O-ring seals may be fitted around each screw 226. Further, a large O-ring seal 228 may be fitted between the receiver insert 218 and the nozzle base 214. In this embodiment, the receiver insert 218 includes a throat 230 that protrudes from the outer face to form a structure that receives the pinion bearing assembly 232, as well as a cone-like inner protrusion 240 that extends from the inner face into the head of the nozzle sheath 706. Referring now to FIGS. 22-24, the inner protrusion 240 defines an inlet gap 242 forming an inlet passage for introducing coolant in the nozzle sheath 706 and an outlet gap 244 forming an outlet passage for receiving coolant returning from the nozzle sheath 706. As noted above, an O-ring seal 246 may be fitted between the bearing assembly 354 and the pinion insert 236 to provide a leaktight seal. The inner face of the receiver insert 218 also defines an inlet channel 248 and an outlet channel 250. The inlet channel 248 provides a flow path for coolant entering through the inlet port 702 to move to the inlet gap 242 in the inner protrusion 240 and eventually into the coolant supply path 710. Similarly, the outlet channel 250 is in fluid communication with the outlet gap 244 to provide a flow path for coolant returning from the nozzle sheath 706 to flow to the outlet port 704.

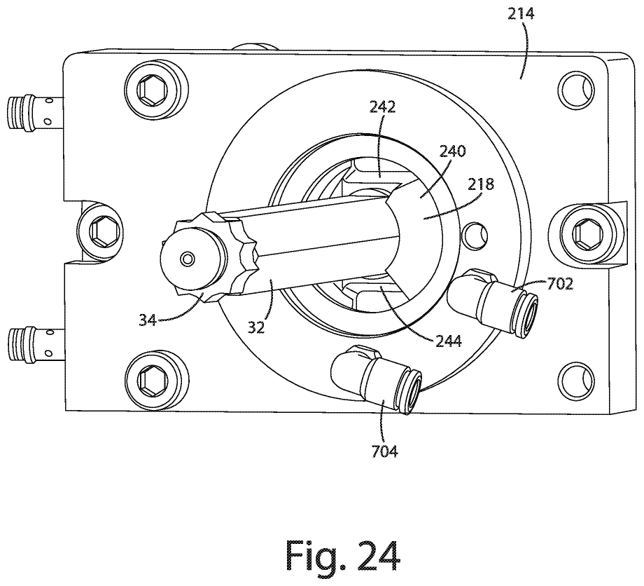

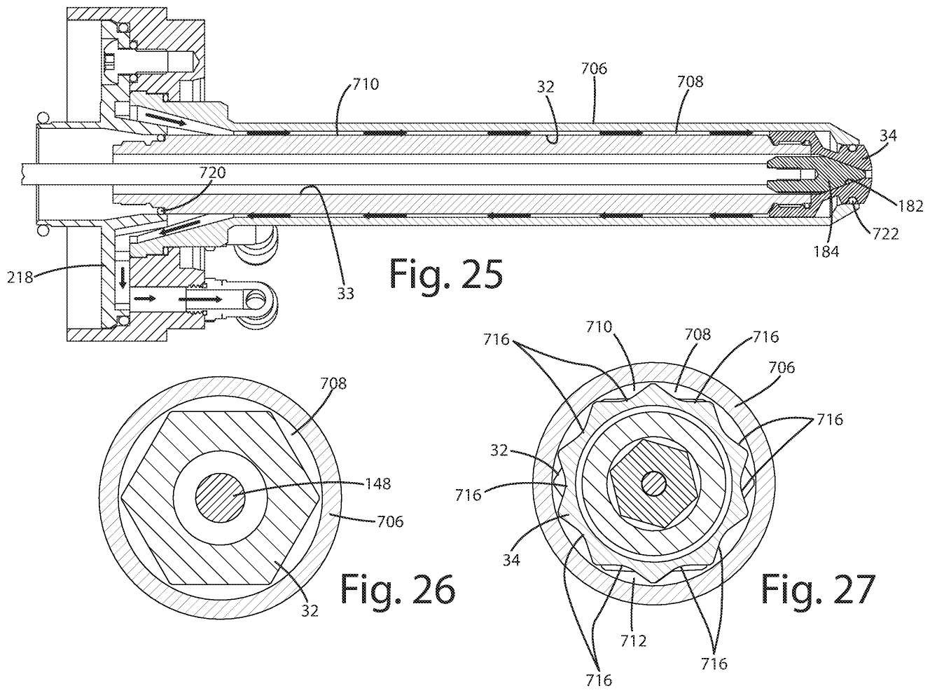

Referring now to FIG. 25, the nozzle sheath 706 defines an interior configured to receive the nozzle 32 as the injection module 18 is mounted to the injection frame 16. In this embodiment, the intermediate space between the nozzle 32 and the nozzle sheath 706 defines a chamber 708 around the exterior of the nozzle 32 to receive cooling liquid. For example, inner and outer seals 702 and 704, respectively, may be disposed toward opposite ends of the nozzle 32 to assist in forming the intermediate sealed chamber 708. In the illustrated embodiment, the exterior of the nozzle 32 and the interior of the nozzle sheath 706 cooperatively define one or more liquid flow paths in the chamber 708 through which a liquid coolant may be moved to cool the nozzle 32 and nozzle tip 34. For example, the intermediate chamber 708 may include a coolant supply path 710 along which liquid coolant is moved to over the nozzle 32 and the nozzle tip 34 and a coolant return path 712 from which cooling liquid returns from the nozzle tip 34 along the nozzle 32. In the illustrated embodiment, the external shape of the nozzle 32 and the internal shape of the nozzle sheath 706 are configured to define a coolant supply path 710 extending longitudinally from the base of the nozzle sheath 706 to the nozzle tip 34 and a coolant return path extending longitudinally from the nozzle tip 34 back to the base of the nozzle sheath 706. For example, in the illustrated embodiment, the interior of the nozzle sheath 706 is circular in cross-section and the exterior of the nozzle 32 is polygonal in cross-section with the vertices of the polygon closely interacting with the interior of the nozzle sheath 706 to define a plurality of longitudinal passages through the chamber 708 (See FIG. 26). More specifically, each flat side of the nozzle 32 may cooperate with the adjacent portion of the circular interior of the nozzle sheath 706 to form a longitudinally extending passage capable of functioning a liquid flow path. In the illustrated embodiment, the exterior of the nozzle is hexagonal in cross section providing six flat sides and six vertices (See FIG. 24). However, the number of sides and vertices may vary from application to application. In this embodiment, the external dimensions of the nozzle 32 and the internal dimensions of the nozzle sheath 706 are selected so that the vertices provide a sufficient seal with the nozzle sheath 706 to define six longitudinal potential flow paths. In this embodiment, the chamber 708 extends over portions of the nozzle 32 and the nozzle tip 34. To facilitate coolant flow over the nozzle tip 34, the exterior of the nozzle tip 34 may cooperate with the interior of the nozzle sheath 706 to define one or more flow passages. In this illustrated embodiment, the nozzle tip 34 defines a plurality of longitudinally extending flutes 716 (or grooves) that allow liquid supplied through the coolant supply path to flow around the nozzle tip 34 and back to the coolant return path (See FIGS. 24 and 27). In this embodiment, the nozzle tip 34 includes ten radially symmetric flutes 716. Although the cooling system 700 of the illustrated embodiment includes flow passages defined in large part by contours in the exterior surfaces of the nozzle 32 and the nozzle tip 34, the flow passages may alternatively or additionally be formed by contours in the inner surface of the nozzle sheath 706.

In the illustrated embodiment, the liquid cooling system 700 includes a liquid coolant supply (not shown) that moves coolant through the cooling system 700 by a pressure differential. For example, coolant may be introduced into the cooling system 700 under positive pressure and/or withdrawn from the cooling system under negative pressure. In the illustrated embodiment, the liquid cooling system 700 includes an inlet port 702 for receiving a supply of coolant from the liquid coolant supply and an outlet port 704 for returning coolant to the liquid coolant supply. Referring now to FIG. 24, the inlet port 702 and outlet port 704 are, in this embodiment, installed in the nozzle base 214. For example, each port 702, 704 is threadedly fitted into a through-bore in the nozzle base 214 that not only seats the port 702, 704, but also defines a coolant flow path through the nozzle base 214, thereby providing fluid communication between the inlet port 702 and the inlet channel 248 and between the outlet port 704 and the outlet channel 250. During operation, liquid coolant is introduced through inlet port 702 and then flows through the throughbore in the nozzle base 214 into the inlet channel 248 in the face of the receiver insert 218. The liquid coolant continues from the inlet channel 248 through the inlet gap 242 in the inner protrusion 240 to the coolant supply path 710. The coolant flows longitudinally along the coolant supply path 710 cooling the nozzle 32 as it flows. After reaching the nozzle tip 34, the coolant flows through the flutes 716 aligned with the coolant supply path 710 into the space around the nozzle tip 34. The coolant flows around the nozzle tip 34 cooling as it moves. The coolant then exits the space around the nozzle tip 34 flowing through the flutes 716 aligned with the coolant return path 712. In this embodiment, the coolant supply path 710 and the coolant return path 712 are disposed on opposite circumferential sides, thereby allowing the coolant arriving via the coolant supply path 710 to pass over essentially all of the outer surface of the nozzle tip 34 before flowing back into the coolant return path 712. The coolant continues along the coolant return path 712 continuing to cool the nozzle 32 along the way. Once the coolant reaches the receiver insert 218, it flows through the outlet gap 244 to the outlet channel 250 in the inner face of the receiver insert 218. The coolant flows along the outlet channel 250 and through the throughbore in the nozzle base 214 to exit via the outlet port 704. The liquid flow passages of the illustrated embodiment are merely exemplary and the present invention may be implemented with essentially any arrangement of flow passages that deliver liquid coolant to and return coolant from the cooling chamber defined between the nozzle 32 and the nozzle sheath 706. It should be noted that the direction of coolant flow through the illustrated embodiment may be reversed with the outlet port 704 functioning as the inlet port, and the inlet port 702 functioning as the outlet port. More specifically, in this alternative embodiment, the outlet port 704 may be connected to the supply line delivering coolant from the liquid coolant supply and the inlet port 702 may be connected to the return line returning coolant to the liquid coolant supply, thereby causing the coolant to flow in a direction opposite to the arrows shown in FIG. 25.

It should be noted that, in the illustrated embodiment, the nozzle 32 and the nozzle tip 34 are carried by the rotational valve 84 and therefore rotate approximately ninety degrees as the rotational valve 84 is rotated between the fill and inject positions. As a result, the cooling system 700 is configured to accommodate this rotational movement. As noted above, the hexagonal outer shape of the nozzle 32 in this embodiment defines six potential flow passages along the length of the nozzle 32. As the nozzle 32 rotates, different potential flow passages move into operative alignment with the inlet gap 242 and the outlet gap 244. As this occurs, the different potential flow passages that align with the inlet gap 242 become the coolant supply path 710 and the different potential flow passages that align with the outlet gap 244 become the return coolant supply path 710. Further, the nozzle tip 34 includes flutes 716 aligned with each of the potential flow passages (See FIG. 27). As a result, regardless of which potential flow passages are functioning as the supply and coolant return paths at any given time, the coolant has a flow path from the coolant supply path around the nozzle tip 34 to the coolant return path.

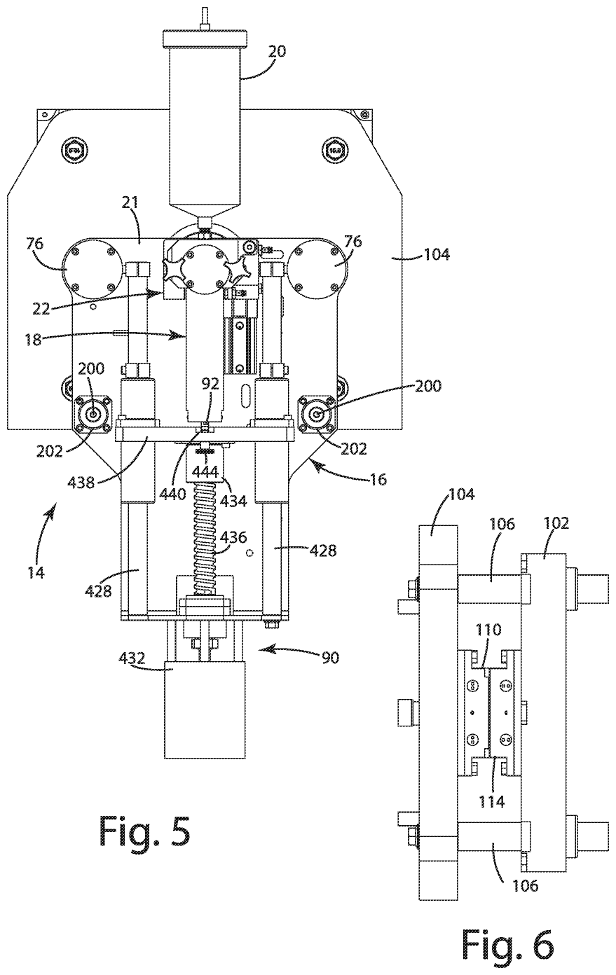

The injection frame 16 also includes an injection rod actuator 90 that is configured to operate the injection rod 92 in the injection module 18. More specifically, the injection rod actuator 90 is operatively coupled to the exposed end of the injection rod 92 that extends from the injection module 18 and is capable of reciprocating motion that allows it to extend and retract the injection rod 92 with respect to the injection module 18. For example, the injection module 18 may be filled with material by operating the injection rod actuator 90 to retract the injection rod 92 and receive material from the material supply connection 20 into the interior of the injection module 18. Once the injection module 18 is filled, the material may be ejected from the injection module 18 and into the mold 13 by operating the injection rod actuator 90 to extend the injection rod 92 and force the material from the interior of the injection module 18 through the nozzle 32 and into the mold 13. The design and configuration of the injection rod actuator may vary from application to application. However, the injection rod actuator 90 of the illustrated embodiment generally includes a motor 432, a ball screw 436, a drive nut 434, a drive plate 438 and a pair of guide rods 428 (See FIGS. 1, 5 and 15). The motor 432 and guide rods 428 are mounted directly to the mounting plate 21. The drive plate 438 is movably fitted over the guide rods 428. The ball screw 436 is coupled to the output shaft of the motor 432 so that rotational movement of the motor 432 results in rotation of the ball screw 436. The drive nut 434 is affixed to the drive plate 438 and fitted over the threads of the ball screw 436 and so that rotation of the ball screw 436 causes the drive nut 434 (and consequently the drive plate 438) to move along the length of the ball screw 436. As shown in FIG. 12, the injection rod 94 includes an exposed end 95 that extends from the interior of the injection module 18. The rod end 95 is fixed to the drive plate 438 so that movement of the drive plate 438 results in movement of the injection rod 94 (See FIG. 5). The rod end 95 may be fixed to the drive plate 438 using essentially any attachment arrangement. However, in the illustrated embodiment, the injection rod 94 and drive plate 438 are configured to allow the injection rod 94 to be easily coupled to and decoupled from the drive plate 438 as the injection module 18 is installed on the injection frame 16. In this embodiment, the rod end 95 has a contoured head that is seated in a corresponding keyway 440 in the drive plate 438. The keyway 440 of the illustrated embodiment is generally triangular and opens outwardly to receive the rod end 95. The wide mouth of the keyway 440 facilitates insertion of the rod end 95 into the keyway 440, while the tapered sidewalls shepherd the rod end 95 into a fully seated position at the innermost end of the keyway 440. The interconnection between the rod end 95 and the keyway 440 may vary from application to application as desired. Referring now to FIG. 12, the rod end 95 includes a reduced diameter portion 97 that is configured to interfit with corresponding contours formed in the innermost end of the keyway 440. The contours are configured to be automatically interfitted with the reduced diameter portion 97 of the rod end 95 as the rod end 95 moves into the fully seated position. In the illustrated embodiment, the drive plate 438 also includes a locking member 444 to secure the rod end 95 in the fully-seated position in the keyway 440. For example, a threaded or spring-loaded retractable pin 444 may be mounted within the keyway 440 in a location where it physically prevents movement of the rod end 95 from its fully seated position. When it is desirable to install or remove the rod end 95 from the keyway 440, the retractable pin 444 may be retracted (e.g. moved down in this embodiment) to provide clearance for the rod end 95. In operation, the motor 432 can be rotated in one direction to lower the drive nut 434 and drive plate 438, and consequently extend the injection rod 94, or it can be rotated in the opposite direction to raise the drive nut 434 and drive plate 438, and consequently cause the injection rod 94 to retract into the injection module 18. If desired, a limit switch (not shown) can be added to the injection rod actuator 90 to provide a signal to the control system when the injection rod has been fully retracted.

The injection rod actuator of this embodiment is merely exemplary and it may be replaced by essentially any other linear actuator capable of providing the injection rod with the desired motion, which in this embodiment is reciprocating linear motion. If desired, the injection rod actuator may also include a load cell configured to allow the control system to dynamically measure force applied to the injection rod 92 to derive injection pressure for a specific diameter injection rod 92.

As noted above, the injection module 18 is removable attachable to the injection molding system 14. This provides a number of advantages. For example, it allows the injection module 18 to be removed for cleaning and allows installation of interchangeable injection modules 18 on the same machine. It also allows an injection module that has not been emptied to be moved into a storage environment that impedes curing and may facilitate use of the material later. For example, with LSR, the injection module 18 may be removed and placed in cold storage to impede curing of the LSR. In the illustrated embodiment, the injection module 18 forms the material flow path from the material supply connection 20 to the mold 13. As a result, removal of the injection module 18 constitutes removal of essentially all of the material within the injection molding system 14, excluding (in this embodiment) only that material that is contained in the material supply connection 20. The injection module 18 of the illustrated embodiment will now be described in more detail with reference to FIGS. 13, 15, 16A-C, 17 and 18. The injection module 18 generally includes a manifold 140, a rotational valve 84, a nozzle 32, an injection cylinder 150 and an injection rod 94. In this embodiment, the manifold 140 is generally cylindrical and defines both a longitudinal bore 600 and a cross-bore 602 that intersects with the longitudinal bore 600. The upper end of the longitudinal bore defines a material inlet 486. A material inlet fitting 142 for coupling with the material supply connection 20 is fitted into the material inlet 486, for example, by threading. The lower portion of the longitudinal bore 600 is configured to receive the tip of the head 93 of the injection rod 92.

The injection cylinder 150 is mounted to the lower end of the manifold 140. For example, the injection cylinder 150 may be threaded to the bottom end of the manifold 140. While the manifold 140 and injection cylinder 150 are threaded in this embodiment, other types of connections may be employed, such as a bayonet connection. In some applications, the manifold 140 and injection cylinder 150 assembly may be replaced by a single one-piece component. The injection cylinder 150 defines an internal bore configured to seat the injection rod 92. In this embodiment, the injection rod 92 includes an enlarged head 93 that is movably seated within the injection cylinder 150 and an extended tip that extends into the longitudinal bore 600. In this embodiment, a pair of seals are fitted around the circumference of the head 93 to create a leaktight seal with the injection cylinder 150. Although the injection rod 92 of the illustrated embodiment includes a cylindrical rod that moves linearly, the injection rod 92 may have alternative constructions. For example, the injection rod may alternatively be a screw configured to rotate within the internal bore.

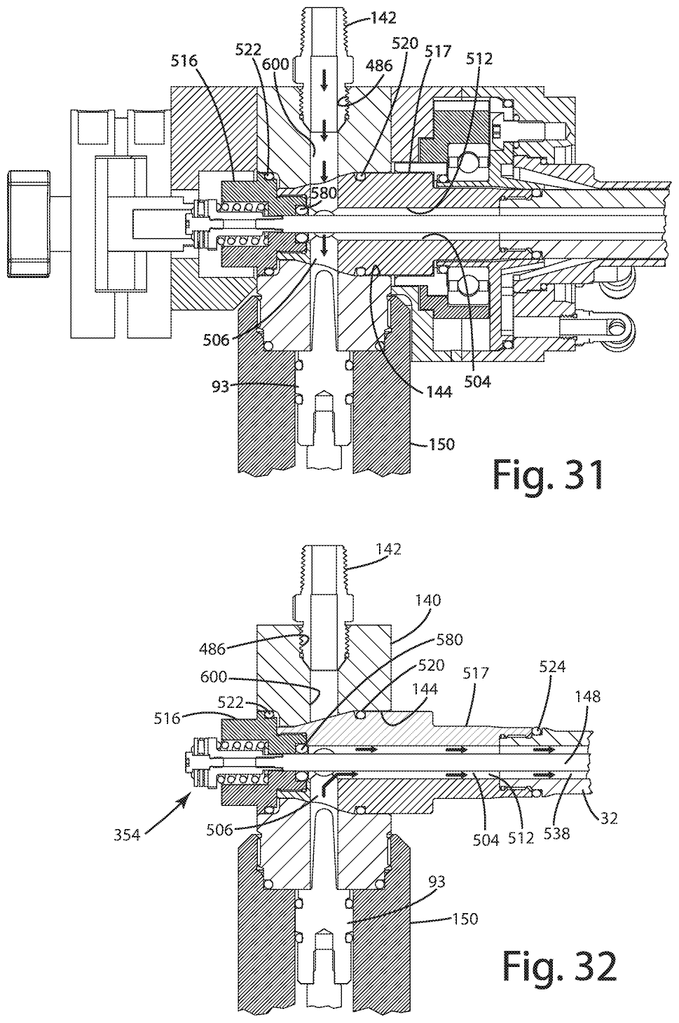

The rotational valve 84 of the illustrated embodiment is configured to seat within the manifold 140. In this embodiment, the rotational valve 84 is rotatably fitted within cross-bore 144 and includes seals 146 toward opposite ends. In this embodiment, the rotational valve 84 includes a valve cap 516 and a valve base 517 that are installed into the cross-bore 144 from opposite sides and joined together, for example, by threading. An O-ring seal 580 is fitted into a counter-bore in the valve cap 516 to create a leaktight seal between the valve cap 516 and the exterior surface of the needle 148. In this embodiment, the valve base 517 generally includes a tapered outer end 502, a through passage 504, a cross passage 506, an annular seat 508 and an inner end 510 with a pair of drive flats 402 (See FIG. 13). The valve base 517 also defines an internal bore 512. The outer end 514 of the internal bore 512 is counterbore and threaded to receive a threaded end the valve cap 516. The inner end of 518 of the internal bore 512 is counterbore and threaded to receive a threaded end on the nozzle 32. The rotational valve 84 is fitted with a plurality of seals, including seal 520 fitted over the annular seat 508, seal 522 fitted over the outer end 502, seal 524 fitted between the inner end of valve base 517 and the nozzle 32. In the illustrated embodiment, the various seals 520, 522, 524 and 526 are O-ring seals, but they may be other types of seals as desired. The manifold 140 defines a tapered seat 500 that is configured to allow passages 504 and 506 in the seated rotational valve 84 to selectively align with the internal bore in the manifold 140. In the fill position, the rotary valve 84 is positioned so that through passage 504 is aligned with in the internal bore in the upper manifold 482. This allows material into the manifold/injection cylinder assembly through the material inlet 486 as the injection rod 92 is retracted. In the inject position, the cross passage 506 is aligned with the internal bore in the manifold 140 in a direction facing the injection rod 92. The cross passage 506 is in fluid communication with internal bore 512 in the rotational valve 84 and, in turn, the internal bore of the nozzle 32. As a result, material contained in the manifold/injection cylinder assembly is expelled through the rotational valve 84, the nozzle 32 and the nozzle tip 34 as the injection rod 92 is extended. As noted above, the rotational valve 84 is moved between the fill position (See FIGS. 17 and 31) and the inject position (See FIGS. 18 and 32) by the rotary valve actuator 82.

The nozzle assembly is coupled to the rotational valve 84. In this embodiment, the nozzle assembly includes the nozzle 32, the nozzle tip 34 and a needle 148 mounted for reciprocating longitudinal movement within the nozzle 32. In this embodiment, the nozzle 32 is an elongated tubular structure having an outer end that is threadedly (or otherwise) secured to the valve base 517. The nozzle 32 defines a cylindrical internal bore 33 through which the needle 148 extends. In this embodiment, the outer surface of the nozzle 32 is configured to assist in defining one or more coolant flow paths between the nozzle 32 and the nozzle sheath 706. For example, the outer surface of the nozzle 32 is hexagonal and the combination of flats and corners of the hexagonal structure interact with the circular internal surface of the nozzle sheath 706 to define six longitudinally extending passages. An O-ring seal 720 is fitted into an annular recess in the nozzle 32 and to form a leaktight seal between the outer surface of the nozzle and the inner surface of the receiver insert 218 as described in more detail below. As noted above, the outer end of the needle 148 is coupled to the valve cap 516 by a spring and a thrust bearing assembly that biases the needle 148 in an outward position and facilitates rotation when the needle 148 is under load from the needle cylinder 350.

In the illustrated embodiment, the needle 148 is fitted within the rotational valve 84 and the nozzle 32. In the illustrated embodiment, the needle 148 is concentrically and coaxially disposed with the internal bore 512 in the rotational valve 84, the internal bore 538 of the nozzle 32 and the internal bore 540 of the valve cap 516. As noted above, a thrust bearing assembly is fitted over the outer end of the needle 148 (See FIG. 13). In use, the needle 148 is axially movable within the rotational valve 84 and the nozzle 32 between an open position in which the nozzle tip 34 is open to discharge material and a closed position in which the nozzle tip 34 is closed by the head 184 of the needle 148. As noted above, the needle 148 is, in this embodiment, biased in the open position. For example, as shown in FIG. 13, a needle return spring 548 is fitted into the internal bore 540 of the valve cap 516. More specifically, the injection module 18 includes a needle return spring 548, such as a coil spring, that is fitted over the needle 148 and is compressed between the T-nut 356 and the valve cap 516.

The nozzle tip 34 is installed on the inner end of the nozzle 32, for example, by threading. The nozzle tip 34 is shaped to fit closely with the nozzle seat 35 in the mold face and defines a tapered internal bore 182 that aligns with the mold gate when the seated. The tapered internal bore 182 is configured to receive the tapered head 184 of the needle 148. When the needle 148 is extended, the head 184 of the needle 148 closes and sealed the nozzle tip 34, and when the needle 148 is retracted, a gap is formed between the head 184 of the needle 148 and the tapered internal bore 182, which allows material to flow out of the nozzle tip 34 and into the mold 13 (Compare FIGS. 17 and 18). A seal 722 is fitted around the nozzle tip 34 to create a leaktight seal between the nozzle tip 34 and the nozzle sheath 706. As noted above, the outer surface of the nozzle tip 34 is fluted or otherwise contoured to define one or more coolant flow paths between the nozzle tip 34 and the nozzle sheath 706. The flutes (or other contours) allow liquid coolant flowing in through the nozzle sheath 706 along the coolant supply path 710 to flow around the nozzle tip 34 and then flow back out of the nozzle sheath 706 along the coolant return path 712. The design and configuration on the nozzle tip 34 may vary from application to application.

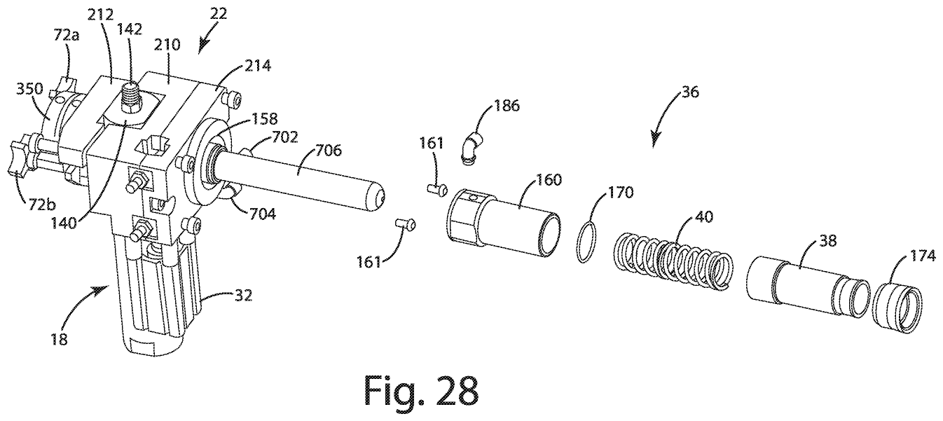

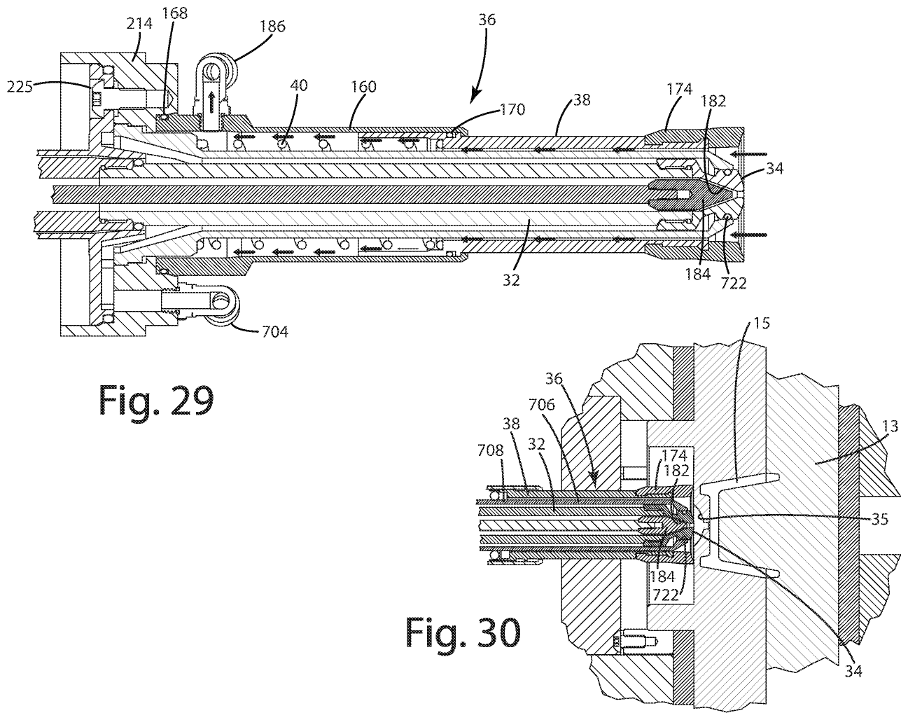

As described above, the injection molding system 14 may include a vacuum system 36 that can be used to draw a vacuum in the mold cavity 15 prior to injection of material (See FIGS. 28 and 29). The vacuum system 36 is optional and may be eliminated when not desired. In the illustrated embodiment, a vacuum seal is created at the mold cavity material inlet so that the mold cavity can be placed in fluid communication with the vacuum source. As a result, when a vacuum is applied and the mold is closed fully, air is drawn from the mold cavity. In this way, the vacuum arrangement allows creation of a partial vacuum in the mold cavity by drawing air through the very channels in the mold through which material normally enters the mold cavity. In the illustrated embodiment, the vacuum system is integrated into the injection frame 16. Referring now to FIG. 25, the vacuum system 36 of the illustrated embodiment generally includes a telescoping vacuum sleeve 38, a spring 40, a sleeve base 160, an air fitting 186 and a vacuum source (not shown). In this embodiment, the sleeve base 160 is mounted to the outer surface of the nozzle base 214. For example, in this embodiment, the nozzle base 214 defines a circumferential recess 158 about the exterior of the nozzle sheath 706. The sleeve base 160 is fitted into the circumferential recess 158 and secured, for example, by fasteners 161. The vacuum sleeve 38 is situated about the nozzle 32 movably contained within the sleeve base 160. For example, the vacuum sleeve 38, nozzle 32 and sleeve base 160 may be concentrically aligned with the vacuum sleeve 38 capable of telescopic movement within the sleeve base 160 over the nozzle 32. In this embodiment, a seal 168 is fitted between the nozzle base 214 and the sleeve base 160. A third seal 170 may be fitted between the sleeve base 160 and the vacuum sleeve 38. The spring 40 is positioned between a shoulder on the nozzle 32 and the end of the vacuum sleeve 38 to urge the vacuum sleeve 38 forward toward the mold 13. Sleeve base 160 may include an air fitting 162 that is coupled to an external vacuum source (not shown) so that a partial vacuum can be drawn in the interior of the vacuum sleeve 38. In this embodiment, the mold end of the vacuum sleeve 38 includes a flexible, resilient tip 174 capable of creating a leaktight interface between the vacuum sleeve 38 and the mold face when in both the vacuum and injection positions (as described in more detail below). The vacuum sleeve tip 174 may be rubber or essentially any other material capable of providing a leaktight seal in the vacuum and injection positions.

Although the illustrated embodiment includes a vacuum sleeve 38 disposed about the nozzle sheath 706, this configuration is merely exemplary and the vacuum system may include essentially any alternative arrangements capable of coupling a vacuum source to the material inlet of the mold. For example, instead of a vacuum sleeve disposed coaxially about the nozzle sheath, the vacuum system may include alternative structure capable of being operatively coupled to a vacuum source and of creating a vacuum seal at the material inlet. For example, the alternative structure may include a vacuum outlet, such as an air line or other fluid flow path, that is physically separate from the nozzle and the nozzle sheath or that is integrated with the nozzle or the nozzle sheath in an arrangement different from that of the illustrated coaxial vacuum sleeve 38. It should also be noted that a vacuum system in accordance with the present invention may be integrated into essentially any injection system and is not limited to use with an injection system having a removably attachable injection module.

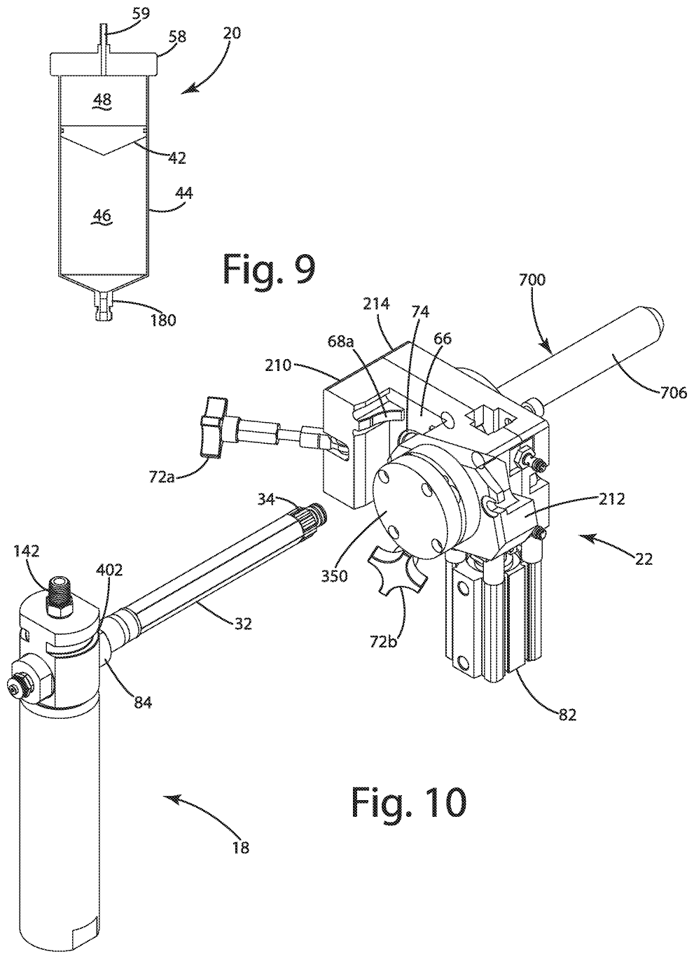

As noted above, the injection molding system 14 includes a material supply connection 20 for supplying material to the injection module 18 (See FIGS. 1, 9 and 15). Referring now to FIG. 9, the material supply connection 20 generally includes an upright cylindrical sleeve 44 with a tapered bottom end that terminates in a material outlet 180. A cap 58 closes the top end of the cylindrical sleeve 44. The cap 58 is affixed to the sleeve 44, for example, by threads, and includes an air inlet 59 through which air can be introduced into the top of material supply connection 20. A floating piston 42 is movably situated inside the cylindrical sleeve 44 to divide the interior of the supply connection 20 into a material chamber 46 and a pressurized air chamber 48. The piston 42 may include one or more rings seals (not shown) to provide a leaktight separation between the material chamber 46 and the air chamber 48. In the illustrated embodiment, a fitting 142 is installed in material outlet 180 to provide a flow path for material to flow from material chamber 46. The fitting 142 is removably secured to the top of the injection module 18. For example, the fitting 142 may have a threaded end that is threadly installed in the material inlet on the injection module 18. The material supply connection 20 may be replaced by other sources of material.

In use, the injection molding system 14 is movable between a retracted position, a vacuum position and an injection position. In the retracted position, the nozzle 32 and vacuum sleeve 38 are moved rearwardly away from the mold 13. In the vacuum position (shown in FIG. 30), the injection molding system 14 is moved forwardly toward the mold 13 to bring the vacuum sleeve 38 into contact with the face of the mold 13. In this position, seal 174 creates a seal between the vacuum sleeve 38 and the mold 13. In this position, a vacuum can be drawn by the vacuum source (not shown), which draws air out of the mold cavity 15 through the vacuum sleeve 38, cross bore 162 and vacuum entry passage 164. A pressure switch (not shown) may be included to indicate when an appropriate vacuum has been achieved. Once the mold cavity 15 is under sufficient vacuum, the injection molding system 14 can be moved into the injection position shown in FIG. 17. In this position, the nozzle tip 34 is directly engaged with the mold inlet creating a leaktight seal that allows material to be injected into the mold cavity 15. It should also be noted that, in this position, the vacuum sleeve 38 has retracted into the collar 160. More specifically, forward movement of the injection molding system 14 may move the vacuum sleeve 38 rearwardly by compressing spring 40.

As described above, the present invention may be implemented in a wide variety of alternative embodiments. The illustrated mold press 12 is merely exemplary, and the present invention may be implemented using other types or styles of presses (horizontal and vertical) that might interface with an injection system or clamping system according to the present invention. Further, the present invention is described in the context of a mold assembly having a pair of mold parts that, when closed, cooperatively define a mold cavity having the shape of the desired molded article. The present invention may, however, be incorporated into injection molding machines that include other types of mold assemblies, including different numbers and combinations of mold parts. For example, although not shown, the mold may include heaters cartridges.

### C. Operation

Operation of the illustrated embodiment will now be described. Operation of the injection molding machine 10 can be generally divided into the following stages: (a) closing the mold, (b) clamping the mold, (c) applying a vacuum to the mold, (d) injecting material in to the mold, (e) curing the molded part and (f) opening the mold and ejecting the molded part. These general stages represent one method for operating the injection molding machine 10. The injection molding machine 10 may be operated in accordance with an alternative method. For example, in some embodiments, the injection system 14 may be used without the vacuum functionality. In such embodiments, the vacuum structure may be eliminated or simply not be used.

In this embodiment, the cooling system 700 may be used to provide cooling to the injection module 18 during part or all of the manufacturing process. In typical applications, the cooling system 700 is operated during the entire manufacturing process, including the time between cycles. During operation, liquid coolant is introduced into the cooling system 700 via inlet port 702, the coolant flows from the inlet port 702 through the nozzle base 214 and into the inlet channel 248 in the receiver insert 218. The coolant follows the inlet channel 248 to the inlet gap 242 and then in the coolant supply path 710 defined in the chamber 708. The coolant flows along the exterior surface of the nozzle 32 though the coolant supply path 710 eventually reaching the nozzle tip 34. At the nozzle tip 34, the coolant flows through the flutes 716 aligned with the coolant supply path 710 into the space surrounding the nozzle tip 34. The coolant then flows along the exterior of the nozzle tip 34 to the flutes 716 aligned with the coolant return path 712. The coolant passes through those flutes 716 and then flows along the exterior surface of the nozzle 32 through the coolant return path 712. The returning coolant flows through the outlet gap 244 and into the outlet channel in the receiver insert 218. The coolant flows along the outlet channel to the throughbore in the nozzle base 214 to exit the cooling system 700 via the outlet port 702. The coolant is supplied to the inlet port 702 under positive pressure and/or withdrawn from the outlet port 704 under negative pressure produced at the coolant source. In this embodiment, coolant is circulated continuously, but it may in alternative embodiments be circulated intermittently as desired. The cooling system 700 and/or the coolant source may include a cooling system for reducing the temperature of the coolant.

Description of the remaining operation of the injection molding machine 10 will begin with the mold press 12 in the closed position and the injection molding system 14 moved away from the mold press 12. As noted above, the mold press 12 is generally conventional and may be opened and closed using conventional techniques and apparatus. Accordingly, the process of opening and closing the mold is not described in detail. Once the mold assembly is closed and the desired clamping force is applied, the injection module 18 is filled with material, for example, liquid silicone rubber (“LSR”). Before filling the injection module 18, the needle cylinder 350 is extended, thereby causing the needle 148 to move inwardly (e.g. toward the mold) to close the outlet end of the nozzle tip 34. To prepare the injection module 18 to receive material, the rotational valve 84 is moved into the fill position (See FIG. 17). In this embodiment, the rotational valve 84 is moved into the “fill” position by the valve actuator 82. As shown in FIG. 14, the linear actuator 83 is retracted to operate the rack-and-pinion arrangement to rotate the rotational valve 84 into the fill position. Once the rotational valve 84 is in the fill position, material can be received into the injection module 18 by the injection rod actuator 90. As noted above, a source of material can be coupled to the material inlet fitting 142. For example, in the context of a liquid silicone rubber (“LSR”) mold, the material reservoir 20 or other material supply connection can be affixed to the material inlet fitting 142. In the illustrated, the material reservoir 20 is typically pressurized to assist in moving viscous material into the injection module 18. For example, pressurized air is introduced into the air chamber via air inlet 59. The air pressure is set to provide the desired motive force on the material based on its viscosity. The injection rod 92 is then retracted by operation of motor 432. As noted above, rotation of the motor 432 turns ball screws 438, which causes linear movement of the drive nut 434 and drive plate 438 along the ball screws 438 and retract the injection rod 92. Operation of the motor 432 can be carefully controlled to ensure the proper amount of material into the manifold/cylinder assembly 480. Retraction of the injection rod 92 receives material from the material reservoir 20 through the manifold 140 into the interior of the injection cylinder 150, which as noted above is typically pressure assisted. After the injection module 18 is loaded with the desired volume of material, the rotational valve 84 is rotated into the inject position by operation of the valve actuator 82 (See FIG. 18). This closes the flow passage from the material supply connection 20 to the interior of the injection cylinder 150.

Once the injection module 18 is filled, the injection molding system 14 is moved into the vacuum position and a vacuum is applied to the mold cavity. As noted above, the vacuum system is optional and the vacuum step may eliminated as desired. To move the injection molding system 14 into the vacuum position, the clamp cylinders 76 are moved until the injection system 14 is in the position shown in FIG. 30 then holding position by blocking air flow on all ports of the clamp cylinders 76 so that the nozzle 32 is not clamped to the mold face. Without clamp force the vacuum sleeve tip 374 can push end of the nozzle slightly away from the mold face. In this position, the vacuum sleeve 238 is engaged with the mold face, but the nozzle 32 is not. Instead, there is at least a small gap or non-air tight connection between the nozzle tip 34 and the nozzle seat 35 in the mold face. Once in the vacuum position, an external vacuum source is applied to the vacuum port 420 to draw a partial vacuum in the mold cavity via the sleeve 38 and the sprue. If desired, a pressure sensor (not shown) may be provided to determine when the vacuum sleeve 238 first contacts to mold face and when the desired vacuum has been achieved. As previously mentioned, a desired vacuum may be achieved with a continuous motion without need to pause and hold position.

Following application of the desired vacuum, the injection molding system 14 is moved into the injection position and material is injected into the mold assembly more freely since the air inside has been extracted. More specifically, the nozzle clamp cylinders 414 are operated to move the injection molding system 14 into the injection position by re-applying air pressure on one set of ports and exhausting the other and fully extending the pneumatic cylinders 414 into the position shown in FIG. 8. During this step, air pressure can be used to apply constant clamp force between the nozzle tip 34 and the nozzle seat 35 in the face of the mold. In this position, the nozzle tip 34 is seated firmly in the nozzle seat 35 in the mold face. The needle 148 is then retracted into the open position by retracting needle cylinder 350. In this embodiment, the needle return spring 368 helps to move the needle cylinder 350 and needle 148 into the open position. Once the needle 148 is open, the injection rod 92 is extended by operation of motor 432. Again, rotation of the motor 432 turns ball screws 438, which causes the drive nut 434 and drive plate 438 to travels along the ball screws 438 to extend the injection rod 92. Operation of the motor 432 can be controlled to ensure the proper dosage of material is ejected into the mold 13. Additionally or alternatively, a load cell washer or other load sensor (not shown) may be used to measure the amount of force applied to the injection rod 92. After the mold cavity has been filled, the needle 148 may be extended by operation of the needle cylinder 350 to close the nozzle tip 34. For purposes of disclosure, operation of the present invention is described in the context of a method in which material is received into the injection module 18 before the vacuum has been applied. In alternative embodiments, the injection module 18 may be loaded with material after the vacuum is applied.

In typical applications, it may be desirable to retain the injection system 14 in the injection position until the material has had sufficient time to cure in the inlet portion of the sprue. Once the material is sufficiently cured, the injection system 14 may be moved away from the mold assembly to the open position by operation of nozzle clamp cylinders 414. The mold press 12 remains clamped until the material has sufficiently cured. The mold halves are typically fitted with heater cartridges and thermocouple sensors for heat cured LSR material. The heater cartridges controlled with a temperature controller such as the systems offered by Omega Engineering. Mold tools are typically brought up to a set temperature such as 300 degrees F. for fast curing of LSR material. An additional control system may include a timer and may be programmed to wait a predetermined period for curing before opening the mold press 12. Non-heat cured materials may be cured using the appropriate curing methods. For example, UV-cured LSR is cured with only ultraviolet light at room temperature. No heater cartridge, sensors or temperature control system are needed for UV-cured LSR. Instead, special mold materials, such as clear acrylic, are created to allow a UV light source in to the mold assembly to cure the material.

When the molded part is sufficiently cured, the mold press 12 is opened using conventional techniques and apparatus. For example, the mold press 12 may be opened, the parts of the mold may be separated and the molded part may be removed from the mold. As noted above, the mold press 12 may include a conventional ejector assembly to assist in separating the molded part from the mold cavity 15.

As can be seen, the illustrated injection molding machine 10 includes a removably attachable injection module 18 that can be readily removed and cleaned with greater ease. A spare (pre-cleaned) injection module could also be used to swap out one in the machine 10 that needs cleaned reducing material change over time to minutes. In this embodiment, the injection module 18 includes all components that come in contact with the material being molded so no cleaning of machine components are required. The present invention is not, however, limited to embodiments in which injection modules includes all the components that contact the material. Further, in this embodiment, the injection module 18 is removably attachable to the machine 10, which allows it to be cleaned more easily. In this embodiment, the machine 10 provides all of the mechanisms used to actuate the injection process, including moving the injection rod 92, traversing the nozzle 32 to and from the mold 13, rotational valve 84 operation and seating and unseating the needle 148 inside the nozzle tip 34. This means that the actuators do not need to be duplicated in each injection module, thereby reducing overall cost when interchangeable injection modules are used. The injection module 18 design shown is for liquid silicone rubber (“LSR”) and uses an injection rod. Components of the injection module 18 that come in contact with the material are the injection rod 92, the inlet fitting 142, inside bores of the manifold assembly 480, the rotational valve 84, the inside bore of the nozzle 32, the exterior of the needle 148 and the inside of the nozzle tip 341. The injection module can be readily cleaned without the solvents typically needed to clean injection systems. When the injection module components are disassembled, the individual parts are relatively small with straight through holes. Further, O-rings are positioned to protect the material from contacting the threads. Placing the assembled injection module or the individual components into a small oven and bake curing the LSR can be achieved in minutes. Once the material has cured it, turns into rubber cylinder shaped pieces that can be pulled or pushed out of their respective bores (e.g. the manifold bore). Cured material on exterior surfaces like the needle or injection rod can simply be peeled away. Once the cured material is removed from the components, the injection module can be re-assembled and ready for use. Although all of the actuators are carried by the machine rather than the injection module in the illustrated alternative embodiment, this is not strictly necessary and the present invention may be implemented with one more of the actuators integrated into the injection module.

### D. Alternative Embodiment

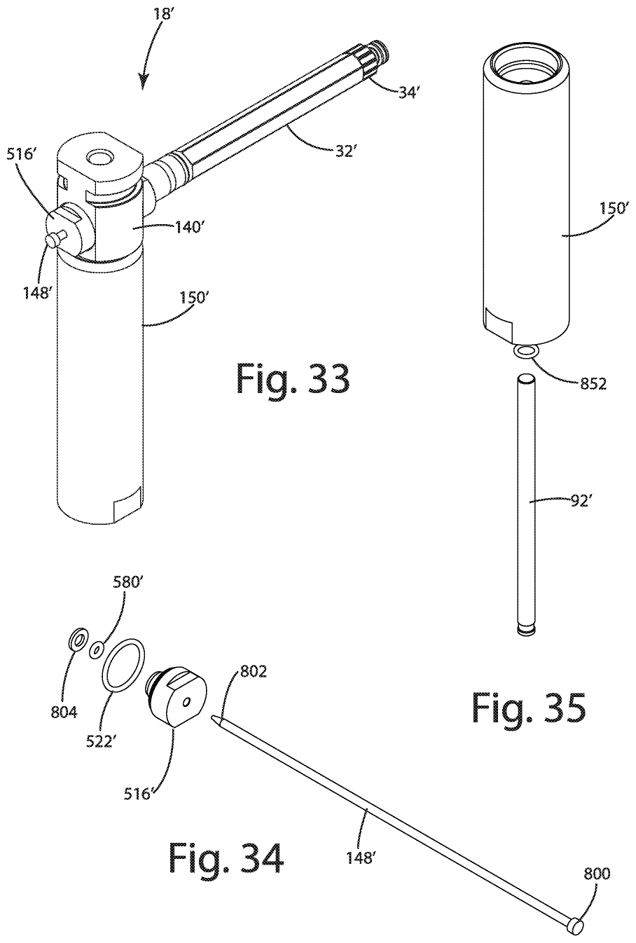

An alternative embodiment of the present invention is shown in FIGS. 33-39. This embodiment incorporates a number of revisions that may be incorporated into embodiments of the present invention individually or in combination. FIG. 33 is a perspective view of an alternative injection module 18′. The alternative injection module 18′ is generally identical to injection module 18, except as expressly described or shown in FIGS. 33-39. To facilitate disclosure, FIGS. 33-39 are provided with reference numerals that correspond with those used in connection with FIGS. 1-32, except followed by the prime symbol. For example, injection module 18′ corresponds with injection module 18, needle 148′ corresponds with injection module 148 and nozzle 32′ corresponds with nozzle 32.

The injection module 18′ of this embodiment includes modifications centered primarily around an alternative needle 148′ (see FIG. 34) and an alternative injection rod 92′ (see FIG. 35). The alternative needle 148′ combines a number features into a single component and eliminates the need for various parts incorporated into injection module 18, such as tapered head 184, thrust bearing assembly 354, T-nut 356, shoulder screw 364 and compression spring 368. The alternative injection rod 92′ operates within an alternative injection cylinder 150′ to eliminate the need for piston head 93.

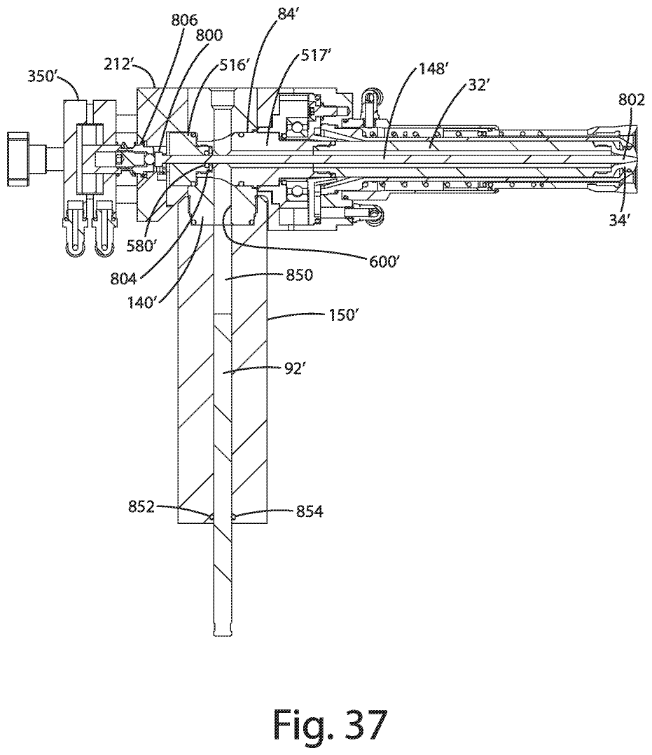

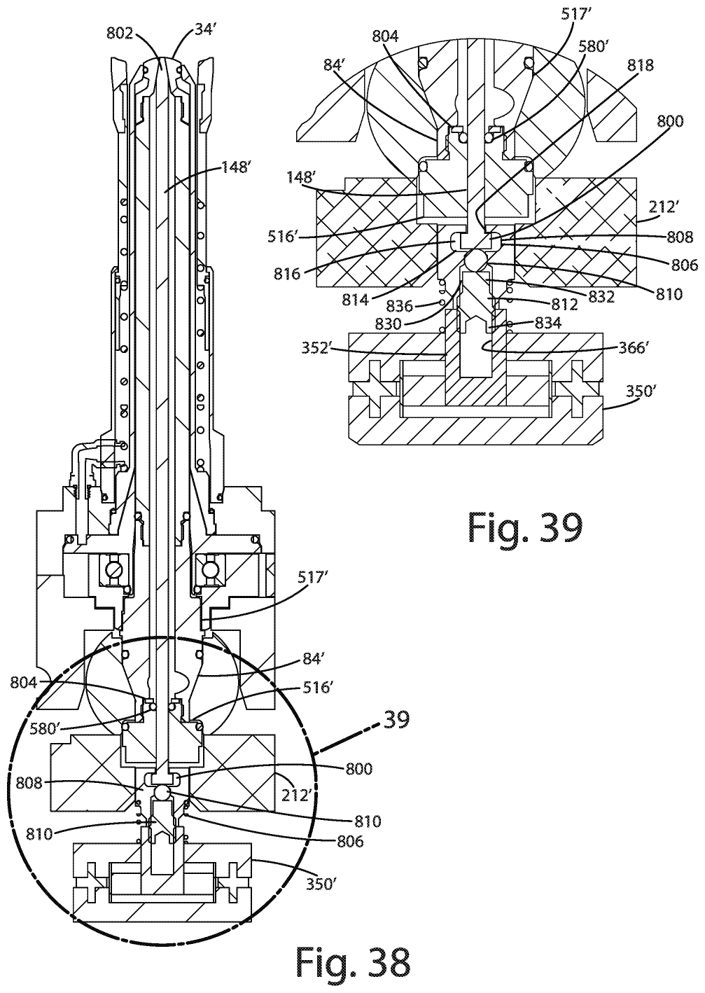

Referring now to FIG. 34, the needle 148′ is an elongated shaft having an enlarged head 800 at one end and a tapered tip 802 at the other. As shown in FIGS. 37 and 38, the tapered tip 802 is configured so that reciprocating motion of the needle 148′ selectively open or close the nozzle 32′ without the need for a separate tapered head. As can be seen, the external shape of the tapered tip 802 corresponds with the internal shape of the tapered internal bore 182′ defined within the nozzle tip 34′. Given the forces that may be encountered during operation, the needle 148′ may be manufactured from hardened steel or other materials capable of withstanding the operating conditions.

As with injection module 18, the needle 148′ is carried by the rotational valve 84′. As perhaps best shown in FIGS. 37 and 38, the rotational valve 84′ has a valve cap 516′ and a valve base 517′, with the valve cap 516′ configured to receive and support the needle 148′. In this embodiment, the valve cap 516′ defines a central through-bore in which the needle 148′ is movably seated. An O-ring seal 580′ is fitted into an inner counter-bore in the valve cap 516′ to create a leaktight seal between the valve cap 516′ and the exterior surface of the needle 148′. In this embodiment, a washer 804 is fitted into an outer counter-bore in the valve cap 516′ to capture and retain the O-ring seal 580′.

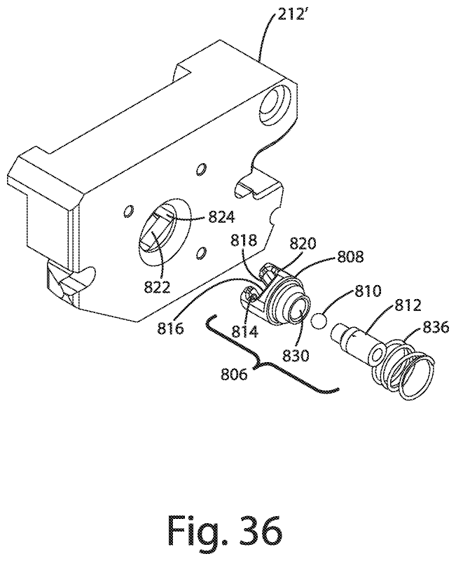

In this embodiment, the head 800 of the needle 148′ is configured to automatically couple with the needle cylinder 350′ when the manifold clamp 212′ is closed and automatically decouple from the needle cylinder 350′ when the manifold clamp 212′ is opened. To facilitate this automatic feature, the needle cylinder 350′ is fitted with a latch assembly 806 that is configured to be interfitted with the head 800. As perhaps best shown in FIG. 33, the head 800 of the needle 148′ protrudes from the outer end of the injection module 18′ where it is exposed for engagement with the latch assembly 806. In this embodiment, the latch assembly 806 generally includes a latch 808, a bearing 810 and a coupler 812. As shown in FIG. 36, the latch 808 includes a transverse C-shaped channel 814 configured to travel over and entrap the head 800 of the needle 148′ as the manifold clamp 212′ rotates into the closed position. In this embodiment, the C-shaped channel 814 has an interior 816 sized and shaped to receive the head 800 and a mouth 818 that is narrower than the head 800, but wide enough for the shaft of the needle 148′. The edges of the latch 808 leading into the channel 814 may be angled to shepherd the latch 808 and the head 800 into proper interfitting relationship. The latch 808 is oriented so that the C-shaped channel 814 remains aligned with the head 800 as the manifold clamp 212′ is closed. To ensure proper alignment, the latch 808 is, in this embodiment, keyed to the manifold clamp 212′ in the desired orientation. For example, in this embodiment, the latch 808 includes flats 820 that interface with corresponding flats 822 inside bore 824 (See FIG. 36).

In the illustrated embodiment, the latch assembly 806 includes a bearing 810 to facilitate rotational movement of the needle 148′ relative to the latch assembly 806, which occurs, for example, when the rotational valve 84′ is rotated between the fill and inject positions. In operation, the bearing 810 provides a single point of contact with the head 800, which allows close to friction-free rotation. In the illustrated embodiment, the bearing 810 is a steel ball bearing that is fitted into the interior of the latch 808 and protrudes a small amount into the C-shaped channel 814 to engage the center of the head 800. As perhaps best shown in FIG. 39, the bearing 810 is fitted into a cylindrical bore 830 in the latch 808 and secured by coupler 812. In this embodiment, the coupler 812 includes an inner end 832 and an outer end 834. The inner end 832 is threadedly secured within the cylindrical bore 830 to hold the bearing 810 in the protruding position. The outer end 834 extends from the latch 808 and is threadedly secured to the needle cylinder rod 352′. For example, in the illustrated embodiment, the outer end 834 is threadedly fitted into the internal bore 366′ of rod 352′.

In operation, the latch assembly 806 couples the needle 148′ to the needle cylinder 350′ so the needle 148′ travels during extension and retraction of the needle cylinder 350′. This eliminates the need for needle return spring 368. To help ensure proper alignment between the latch 808 and the head 800 of the needle 148′ when the needle cylinder 350′ is not powered, an alignment spring 836 is fitted between the needle cylinder 350′ and the latch 808. The alignment spring 836 applies a bias that urges the latch assembly 806 away from the needle cylinder 350′ into the outermost position where it will be laterally aligned with the head 808 when the needle 148′ is in the closed position. The alignment spring 836 is a compression spring with sufficient spring force to move the latch assembly 806 to the desired position when the needle cylinder 350′ is not in operation.

As noted above, the alternative embodiment of FIG. 33-39 also includes an alternative injection rod 92′. In this embodiment, the injection rod 92′ is configured to fit closely within the internal bore 850 of an alternative injection cylinder 150′. The clearance between the injection rod 92′ and internal bore 850 is small enough to prevent the passage of liquid silicone or other similar materials. As a result, the alternative injection rod 92′ and injection cylinder 150′ do not utilize a separate piston head with piston rings. In this embodiment, a O-ring seal 852 is fitted into an annular recess 854 disposed about the internal bore 850 to provide a seal between the injection rod 92′ and the injection cylinder 150′. The O-ring seal 852 is positioned near the lower end of the injection cylinder 150′ so that it remains engaged with the injection rod 92′ throughout its entire range of motion.

Additionally, in this embodiment, the manifold 140′ defines a longitudinal bore 600′ having the same diameter as the internal bore 850 of the injection cylinder 150′. As a result, the injection rod 92′ is capable of being extended into the longitudinal bore 600′. This eliminates the need for a piston head 93 with a reduced-diameter extended tip, instead allowing the injection rod 92′ itself to move into the longitudinal bore 600′ to drive material from the manifold 140′.

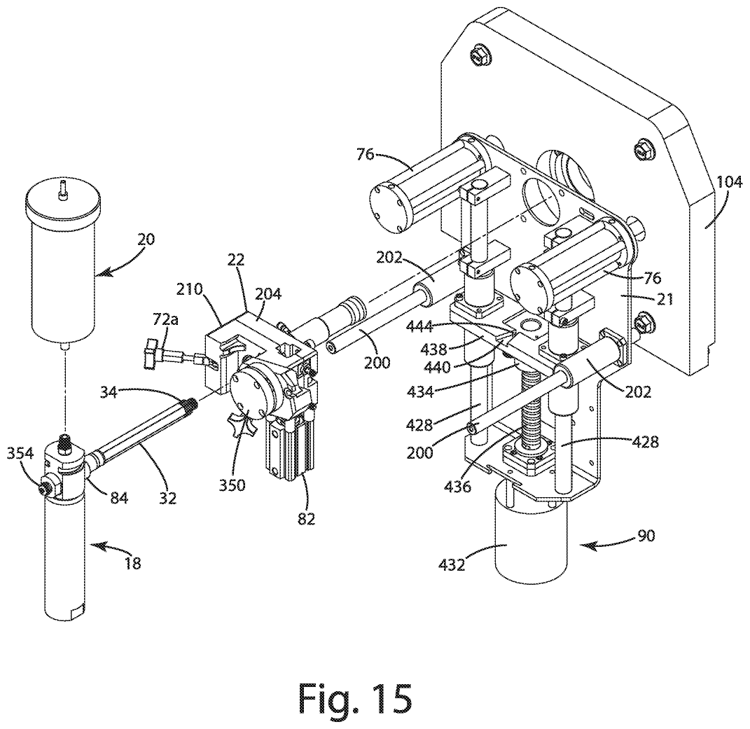

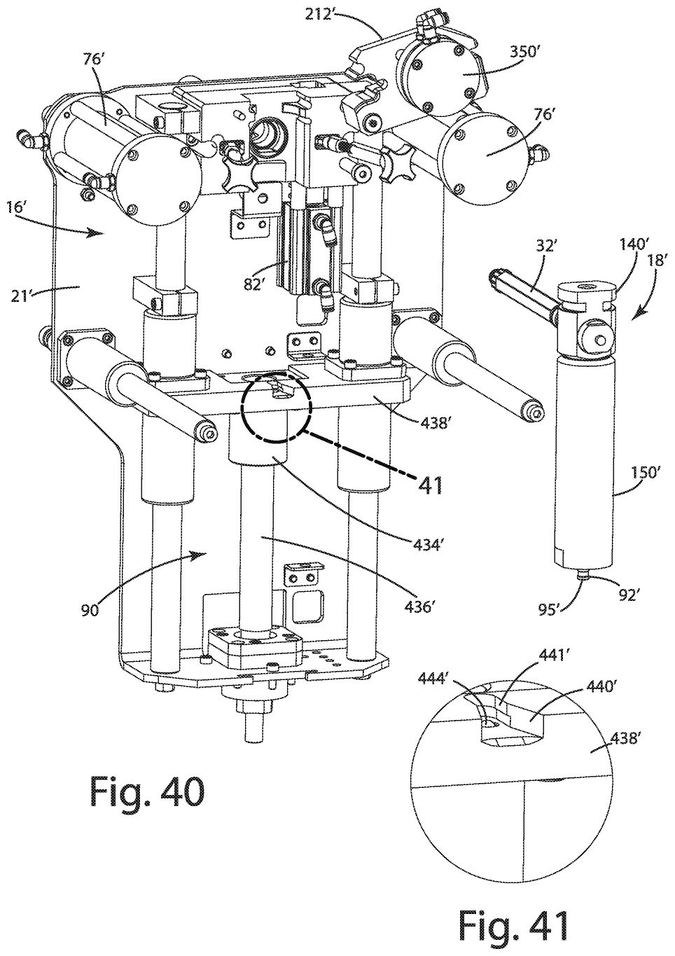

As discussed above in connection with injection molding system 12, the injection rod 92 is moved by an injection rod actuator 90, and the system is designed so that the injection rod 92 easily couples to the injection rod actuator 90 when the injection module 18 is installed in the receiver 22. The embodiment of FIGS. 40-43 shows an alternative arrangement for joining the injection 92′ to the injection rod actuator 90′. As with the arrangement show in FIGS. 5 and 15, the injection rod actuator 90′ is mounted to the injection frame 16′ and is configured to extend and retract the injection rod 92′ within the injection module 18′. More specifically, the exposed end 95′ of the injection rod 92′ is coupled to the drive plate 438′ of the injection rod actuator 90′ so that motion of the drive plate 438′, for example, by operation of motor 432 (as described above in connection with injection rod actuator 90), is communicated to the injection rod 92′. In operation, the drive plate 438′ may be lowered to retract the injection rod 92′ within the injection cylinder 150′ to facilitate loading of the injection cylinder 150′ with material, and raised to extend the injection rod 92′ within the injection cylinder 150′ to eject material from the injection module 18′ into the mold.

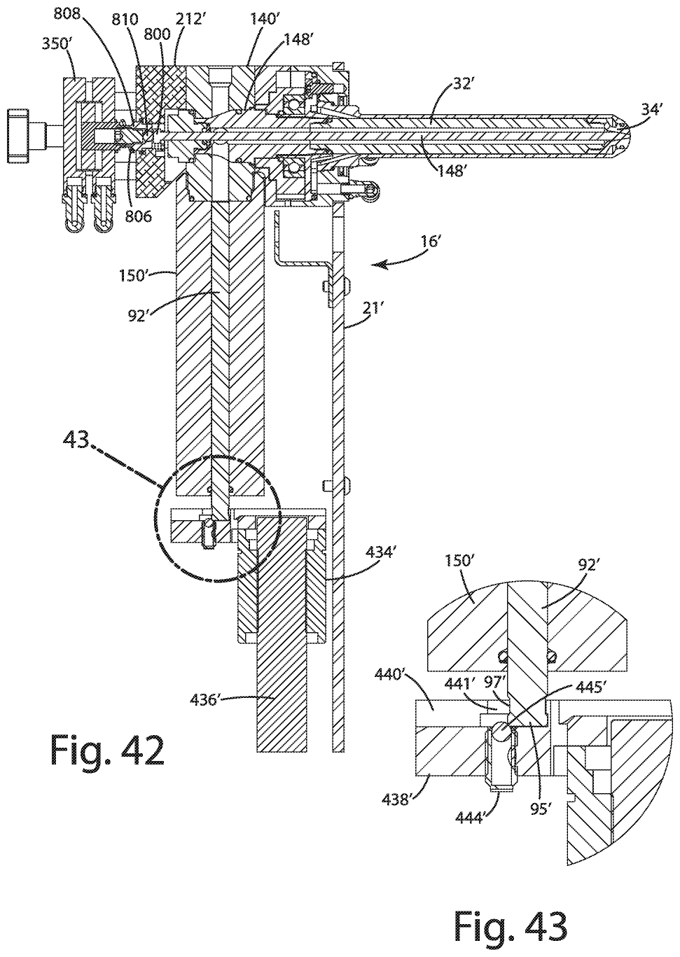

As described above in connection with injection module 18 and injection rod actuator 90, the rod end 95′ may be fixed to the drive plate 438′ using essentially any attachment arrangement. FIGS. 40-43 show an alternative attachment arrangement that is essentially identical to the attachment arrangement described above in connection with injection module 18 and injection rod actuator 90, except that it includes a spring-loaded ball plunger 444′ as the locking member for securing the injection rod end 95′ in the keyway 440′. As with keyway 440, keyway 440′ is a generally triangular, outwardly opening slot that receive the rod end 95′ (See FIG. 41). As shown in FIGS. 42 and 43, the rod end 95′ includes a reduced diameter portion 97′ that interconnects with corresponding contours 441′ formed in the innermost end of the keyway 440′. The contours 441′ are configured to be automatically interfitted with the reduced diameter portion 97′ of the rod end 95′ as the rod end 95′ moves into the fully seated position. As perhaps best shown in FIG. 43, the spring-loaded ball plunger 444′ includes a ball 445′ that protrudes up beyond the floor of the keyway 440′ to physically resist movement of the rod end 95′ from its fully seated position. When it is desirable to install or remove the injection module 18′, the user pushes or pulls the rod end 95′ into or out of the keyway 440′ with sufficient force to overcome the spring bias and cause the ball 445′ to retract (e.g. move down in this embodiment) to provide clearance for the rod end 95′.

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1.-17. (canceled)

18. An injection system for integration into an injection molding machine, the injection molding machine able to receive a mold assembly with a mold cavity and a material inlet comprising:
an injection module removably mounted in an injection module receiver;
the injection module including a nozzle providing a flow path to introduce material into a mold assembly via a material inlet;
the injection module receiver including a nozzle sheath disposed about at least a portion of the nozzle when the injection module is mounted, the nozzle sheath and the nozzle defining an intermediate coolant chamber, the injection module receiver including an inlet port for introducing coolant into the coolant chamber and an outlet port for receiving coolant returning from the coolant chamber.

19. The injection system of claim 18 wherein the injection module receiver includes a vacuum system to selectively draw a partial vacuum in a mold cavity, the vacuum system configured to be coupled to a vacuum source.

20. The injection system of claim 19 wherein the vacuum system includes a vacuum sleeve disposed about the nozzle sheath, the vacuum sleeve being retractable relative to the nozzle sheath.

21. The injection system of claim 20 wherein the vacuum sleeve is telescopically disposed in a vacuum base.

22. (canceled)

23. The injection system of claim 21 wherein the vacuum sleeve is longer than the nozzle sheath and the nozzle so that movement of the injection system toward a mold assembly causes the vacuum sleeve to engage the mold assembly prior to the nozzle.

24. The injection system of claim 23 wherein the vacuum sleeve includes a flexible, resilient tip capable of being resiliently deformed.

25. (canceled)

26. The injection system of claim 23 wherein the coolant chamber includes a coolant supply passage and a coolant return passage; and
wherein the coolant supply passage and the coolant return passage are defined by the interior surface of the nozzle sheath and the exterior surface of the nozzle.

27. (canceled)

28. (canceled)

29. (canceled)

30. The injection system of claim 26 wherein the nozzle includes a nozzle tip, an external surface of the nozzle tip defining a plurality of coolant flow passages.

31. An injection molding system comprising:
a receiver having a manifold clamp, a needle cylinder and a latch assembly, the needle cylinder being mounted to the manifold clamp and configured to be selectively extended and retracted, the latch assembly coupled to the needle cylinder to move with extension and retraction of the needle cylinder; and
an injection module removably mounted to the receiver, the injection module having an injection module inlet for receiving material from a supply of material and defining at least a portion of the flow path from the injection module inlet to a mold, the injection module having a nozzle defining an outlet for ejecting material from the injection module into a mold, the injection module further including a needle disposed within the nozzle, the needle being movable between extended and retracted positions to selectively open and close the nozzle outlet, the needle having a first tapered end closing the outlet when the needle is in the extended position, the needle having a head;
wherein the manifold clamp is movable between open and closed positions to secure the injection module in place in the receiver, the latch assembly configured to automatically engage the head of the needle as the manifold clamp is moved from the open position to the closed position and to automatically disengage from the head of the needle as the manifold clamp is moved from the closed position to the open position, when the latch assembly and the head of the needle are engaged the latch assembly operatively couples the needle to the needle cylinder so that the needle moves with extension and retraction of the needle cylinder.

32. The injection molding system of claim 31 wherein the latch assembly includes a latch defining a channel configured to be interfitted with the head of the needle.

33. The injection molding system of claim 32 wherein the channel is generally C-shaped in cross section.

34. The injection molding system of claim 33 where in the latch assembly includes a bearing engaged with the head of the needle when the latch is interfitted with the head of the needle.

35. The injection molding system of claim 34 wherein the latch defines an internal bore, the bearing being a ball bearing seated within said internal bore.

36. (canceled)

37. An injection module for an injection molding machine comprising:
a manifold defining a material inlet and a manifold material flow path in communication with the material inlet;
an injection cylinder mounted to the manifold, the injection cylinder having a longitudinal extent and defining an internal bore;
an injection rod movably disposed within the internal bore;
a valve mounted within the manifold, the valve defining a valve material flow path, the valve being movable within the manifold;
a nozzle having a longitudinal axis, the nozzle defining a nozzle material flow path in communication with the valve material flow path, the nozzle having a nozzle tip defining a nozzle outlet, the exterior of the nozzle being fluted to provide a plurality of liquid flow paths, the nozzle tip defining a flow path providing communication between at least two of the liquid flow paths; and
a needle disposed within the material flow path, the needle being movable within the internal material flow path to selectively open and close the nozzle outlet; and
wherein the valve is movable between a fill position in which the internal bore of the injection cylinder is in communication with the material inlet via the manifold material flow path so that movement of the injection rod in one direction facilitates loading of the injection module with material and an inject position in which the nozzle material flow path is in communication with the internal bore of the injection cylinder and not in communication with the material inlet so that movement of the injection rod in a second direction ejects material from the injection module through the nozzle outlet.

38. The injection module of claim 37 wherein the manifold defines a tapered seat, the valve being a rotational valve seated in the tapered seat.

39. The injection module of claim 38 wherein the tapered seat intersects with the manifold material flow path dividing the material flow path into first and second portions.

40. The injection module of claim 39 wherein the rotational valve includes a through bore providing communication between the first and second portions of the manifold material flow path when the rotational valve is in the fill position, the rotational valve including a cross bore providing communication between the second portion of the manifold material flow path and the valve material flow path when the rotational vale is in the inject position.

41. The injection module of claim 40 wherein the injection rod includes an exposed end, the exposed end defining a head configured to attach to an injection rod actuator.

42. The injection module of claim 41 wherein the needle includes an exposed head, the exposed head configured to attach to a needle actuator.

43. (canceled)

44. The injection module of claim 37 wherein the nozzle and the nozzle tip are separate.
